(19) United States
(12) Patent Application Publication
(10) Pub. No.: US 2008/0215994 A1
(43) Pub. Date: Sep. 4, 2008

(54) Virtual world avatar control, interactivity and communication interactive messaging

(76) Inventors: Phil Harrison, London (GB); Gary M. Zalewski, Oakland, CA (US)

Correspondence Address: MARTINE PENILLA & GENCARELLA, LLP, 710 LAKEWAY DRIVE, SUITE 200, SUNNYVALE, CA, 94085, US

(21) Appl. No.: 11/789,325

(22) Filed: Apr. 23, 2007

Related U.S. Application Data
(60) Provisional application No. 60/892,397, filed on Mar. 1, 2007.

(51) Int. Cl. G06F 3/048

(52) U.S. Cl. 715/757

(57) ABSTRACT

Methods and systems for rendering an interactive virtual environment for communication is provided. The interactive virtual environment is depicted from images to be displayed on a display and the interactive virtual environment is generated by a computer program that is executed on at least one computer of a computer network system. The interactive virtual environment includes one or more virtual user avatars controlled by real-world users. The method further includes controlling a virtual user avatar to move about a virtual space and generating an interface for composing a message to be displayed as a virtual message within the virtual space. The virtual message is posted to an interactive space within the virtual space. The method further includes associating permissions to the virtual message, such that the permissions define which of the one more virtual user avatars are able to view the virtual message that is posted to the interactive space. The virtual message is one of a plurality of virtual message posted to the interactive space, and the permissions prevent viewing of the virtual message by virtual user avatars that do not have permission to view the virtual message. The permissions may be based on one of buddy lists, game familiarity relative to other real-world users, skill level of other real-world users, and combinations thereof. In some embodiments, the avatars can be computer controlled bots, thus not requiring a real-world user to dictate control.

### CLAIM OF PRIORITY

This Application claims priority to U.S. Provisional Patent Application No. 60/892,397, entitled “VIRTUAL WORLD COMMUNICATION SYSTEMS AND METHODS”, filed on Mar. 1, 2007, which is herein incorporated by reference.

### CROSS-REFERENCE TO RELATED APPLICATION

This application is related to: (1) U.S. patent application Ser. No. ______, (Attorney Docket No. SONYP066/SCEA06112US00) entitled “Interactive User Controlled Avatar Animations”, filed on the same date as the instant application, (2) U.S. patent application Ser. No. ______, (Attorney Docket No. SONYP068/SCEA06114US00) entitled “Virtual World User Opinion & Response Monitoring”, filed on the same date as the instant application, (3) U.S. patent application Ser. No. 11/403,179 entitled “System and Method for Using User's Audio Environment to Select Advertising”, filed on 12 Apr. 2006, (4) U.S. patent application Ser. No. 11/407,299 entitled “Using Visual Environment to Select Ads on Game Platform”, filed on 17 Apr. 2006, (5) U.S. patent application Ser. No. 11/682,281 entitled “System and Method for Communicating with a Virtual World”, filed on 5 Mar. 2007, (6) U.S. patent application Ser. No. 11/682,284 entitled “System and Method for Routing Communications Among Real and Virtual Communication Devices”, filed on 5 Mar. 2007, (7) U.S. patent application Ser. No. 11/682,287 entitled “System and Method for Communicating with an Avatar”, filed on 5 Mar. 2007, U.S. patent application Ser. No. 11/682,292 entitled “Mapping User Emotional State to Avatar in a Virtual World”, filed on 5 Mar. 2007, U.S. patent application Ser. No. 11/682,298 entitled “Avatar Customization”, filed on 5 Mar. 2007, and (8) U.S. patent application Ser. No. 11/682,299 entitled “Avatar Email and Methods for Communicating Between Real and Virtual Worlds”, filed on 5 Mar. 2007, each of which is hereby incorporated by reference.

### BACKGROUND

### Description of the Related Art

The video game industry has seen many changes over the years. As computing power has expanded, developers of video games have likewise created game software that takes advantage of these increases in computing power. To this end, video game developers have been coding games that incorporate sophisticated operations and mathematics to produce a very realistic game experience.

Example gaming platforms, may be the Sony Playstation or Sony Playstation2 (PS2), each of which is sold in the form of a game console. As is well known, the game console is designed to connect to a monitor (usually a television) and enable user interaction through handheld controllers. The game console is designed with specialized processing hardware, including a CPU, a graphics synthesizer for processing intensive graphics operations, a vector unit for performing geometry transformations, and other glue hardware, firmware, and software. The game console is further designed with an optical disc tray for receiving game compact discs for local play through the game console. Online gaming is also possible, where a user can interactively play against or with other users over the Internet.

As game complexity continues to intrigue players, game and hardware manufacturers have continued to innovate to enable additional interactivity and computer programs. Some computer programs define virtual worlds. A virtual world is a simulated environment in which users may interact with each other via one or more computer processors. Users may appear on a video screen in the form of representations referred to as avatars. The degree of interaction between the avatars and the simulated environment is implemented by one or more computer applications that govern such interactions as simulated physics, exchange of information between users, and the like. The nature of interactions among users of the virtual world is often limited by the constraints of the system implementing the virtual world.

It is within this context that embodiments of the invention arise.

### SUMMARY OF THE INVENTION

Broadly speaking, the present invention fills these needs by providing computer generated graphics that depict a virtual world. The virtual world can be traveled, visited, and interacted with using a controller or controlling input of a real-world computer user. The real-world user in essence is playing a video game, in which he controls an avatar (e.g., virtual person) in the virtual environment. In this environment, the real-world user can move the avatar, strike up conversations with other avatars, post messages, and filter content. Filtered content may be messages that can be posted in the virtual world, such that selected other avatars can view, read, or communicate in regard to such messages. In other embodiments, real-world users need not be controlling the avatars seen on the display screen. In such a case, the avatars shown in a virtual space may be bots that are controlled by a machine. Avatar bots, therefore, can move around the virtual space in a similar way as do the avatars that are controlled by a user. Still further, the bots can be set to interact in defined manners, modify environments, post advertising, post messages, build virtual spaces, virtual buildings, or construct virtual pieces or collections of pieces. Thus, several embodiments defining method for communication, filtering and displaying information are discussed herein, and are defined by the appended claims.

In one embodiment, an interactive virtual environment for communication is provided. The interactive virtual environment is depicted from images displayed on a display and the interactive virtual environment is generated by a computer program that is executed in a computer network system, the virtual environment including one or more virtual user avatars controlled by real-world users. The method includes controlling a virtual user avatar to move about a virtual space and composing a message and generating a virtual message within the virtual space. The virtual message is applied to an interactive space within the virtual space. The method includes assigning permissions to the virtual message, where the permissions define which of the one more virtual user avatars are able to view the virtual message that is applied to an interactive space. The virtual message is one of a plurality of virtual message applied to the interactive space, and the permissions prevent viewing of the virtual message by virtual user avatars that do not have permission to view the virtual message.

In another embodiment, a method for rendering an interactive virtual environment for communication is defined. The interactive virtual environment is depicted from images to be displayed on a display and the interactive virtual environment is generated by a computer program that is executed on at least one computer of a computer network system. The interactive virtual environment includes one or more virtual user avatars controlled by real-world users. The method further includes controlling a virtual user avatar to move about a virtual space and generating an interface for composing a message to be displayed as a virtual message within the virtual space. The virtual message is posted to an interactive space within the virtual space. The method further includes associating permissions to the virtual message, such that the permissions define which of the one more virtual user avatars are able to view the virtual message that is posted to the interactive space. The virtual message is one of a plurality of virtual message posted to the interactive space, and the permissions prevent viewing of the virtual message by virtual user avatars that do not have permission to view the virtual message. In this embodiment, the permissions are based on one of buddy lists, game familiarity relative to other real-world users, skill level of other real-world users, and combinations thereof.

In one embodiment, a method for rendering an interactive virtual environment for communication is defined. The interactive virtual environment is depicted from images to be displayed on a display and the interactive virtual environment is generated by a computer program that is executed on at least one computer of a computer network system. The interactive virtual environment includes one or more virtual user avatars controlled by real-world users. The method includes controlling a virtual user avatar to move about a virtual space and generating an interface for composing a message to be displayed as a virtual message within the virtual space. The virtual message is posted to an interactive space within the virtual space. The method associates permissions to the virtual message, and the permissions define which of the one more virtual user avatars are able to view the virtual message that is posted to the interactive space. The method graphically displays the virtual message as a graphic image in a scene of the virtual space. The method further enables moving the graphic image of the virtual message through graphic control of a virtual user avatar, where the virtual user avatar is controlled by a real-world user through a controller.

Other aspects and advantages of the invention will become apparent from the following detailed description, taken in conjunction with the accompanying drawings, illustrating by way of example the principles of the invention.

### BRIEF DESCRIPTION OF THE DRAWINGS

The invention, together with further advantages thereof, may best be understood by reference to the following description taken in conjunction with the accompanying drawings.

FIGS. 1A and 1B illustrate examples of a conceptual virtual space for real-world users to control the movement of avatars in and among the virtual spaces, in accordance with one embodiment of the present invention.

FIG. 2A illustrates a virtual meeting space to allow users to congregate, interact with each other, and communicate, in accordance with one embodiment of the present invention.

FIG. 2B illustrates interactive spaces that can be used by avatars to communicate with one another, in accordance with one embodiment of the present invention.

FIG. 2C illustrates the control by real-world users of avatars in a virtual space, in accordance with one embodiment of the present invention.

FIGS. 3A and 3B illustrate profile information that may be provided from users, in accordance with one embodiment of the present invention.

FIG. 4 illustrates a messaging board that may be used to post messages by avatars, in accordance with one embodiment of the present invention.

FIGS. 5A and 5B illustrate filtering of messages for users based on privileges, in accordance with one embodiment of the present invention.

FIGS. 5C through 5F illustrate additional examples of filtering that may be used to allow certain users to view messages, in accordance with one embodiment of the present invention.

FIG. 6 illustrates the posting of a message by an avatar in a meeting space, in accordance with one embodiment of the present invention.

FIGS. 7A through 7C illustrate an avatar using glasses to filter or allow viewing of specific messages in a meeting place, in accordance with one embodiment of the present invention.

FIG. 8 illustrates a process that determines whether certain avatars are able to view messages posted in a meeting space, in accordance with one embodiment of the present invention.

FIG. 9 illustrates shapes, colors, and labels that may be used on messages that are to be posted by avatars, in accordance with one embodiment of the present invention.

FIG. 10 illustrates graffiti and artwork being posted on objects in a virtual space to convey messages, in accordance with one embodiment of the present invention.

FIGS. 11A through 11C illustrate filtering that may be performed to identify specific users within meeting spaces, based on buddy list filtering, in accordance with one embodiment of the present invention.

FIGS. 12A through 12C illustrate additional filtering performed based on common game ownership, in accordance with one embodiment of the present invention.

FIGS. 13A through 13C illustrate additional filtering that may be combined by analysis of common game ownership and common skill level, in accordance with one embodiment of the present invention.

FIG. 14 illustrates a hardware and user interfaces that may be used to interact with the virtual world and its processing, in accordance with one embodiment of the present invention.

FIG. 15 illustrates additional hardware that may be used to process instructions, in accordance with one embodiment of the present invention.

### DETAILED DESCRIPTION

In the following description, numerous specific details are set forth in order to provide a thorough understanding of the present invention. It will be apparent, however, to one skilled in the art that the present invention may be practiced without some or all of these specific details. In other instances, well known process steps have not been described in detail in order not to obscure the present invention.

According to an embodiment of the present invention users may interact with a virtual world. As used herein the term virtual world means a representation of a real or fictitious environment having rules of interaction simulated by means of one or more processors that a real user may perceive via one or more display devices and/or may interact with via one or more user interfaces. As used herein, the term user interface refers to a real device by which a user may send inputs to or receive outputs from the virtual world. The virtual world may be simulated by one or more processor modules. Multiple processor modules may be linked together via a network. The user may interact with the virtual world via a user interface device that can communicate with the processor modules and other user interface devices via a network. Certain aspects of the virtual world may be presented to the user in graphical form on a graphical display such as a computer monitor, television monitor or similar display. Certain other aspects of the virtual world may be presented to the user in audible form on a speak, which may be associated with the graphical display.

Within the virtual world, users may be represented by avatars. Each avatar within the virtual world may be uniquely associated with a different user. The name or pseudonym of a user may be displayed next to the avatar so that users may readily identify each other. A particular user's interactions with the virtual world may be represented by one or more corresponding actions of the avatar. Different users may interact with each other in the public space via their avatars. An avatar representing a user could have an appearance similar to that of a person, an animal or an object. An avatar in the form of a person may have the same gender as the user or a different gender. The avatar may be shown on the display so that the user can see the avatar along with other objects in the virtual world.

Alternatively, the display may show the world from the point of view of the avatar without showing itself. The user's (or avatar's) perspective on the virtual world may be thought of as being the view of a virtual camera. As used herein, a virtual camera refers to a point of view within the virtual world that may be used for rendering two-dimensional images of a 3D scene within the virtual world. Users may interact with each other through their avatars by means of the chat channels associated with each lobby. Users may enter text for chat with other users via their user interface. The text may then appear over or next to the user's avatar, e.g., in the form of comic-book style dialogue bubbles, sometimes referred to as chat bubbles. Such chat may be facilitated by the use of a canned phrase chat system sometimes referred to as quick chat. With quick chat, a user may select one or more chat phrases from a menu.

In embodiments of the present invention, the public spaces are public in the sense that they are not uniquely associated with any particular user or group of users and no user or group of users can exclude another user from the public space. Each private space, by contrast, is associated with a particular user from among a plurality of users. A private space is private in the sense that the particular user associated with the private space may restrict access to the private space by other users. The private spaces may take on the appearance of familiar private real estate. In other embodiments, real-world users need not be controlling the avatars seen on the display screen. Avatars shown in a virtual space may be bots that are controlled by a machine. Avatar bots, therefore, can move around the virtual space in a similar way as do the avatars that are controlled by a real-world user, however, no real-world user is actually controlling the avatar bots. In many ways, the avatar bots can roam around a space, take actions, post messages, assign privileges for certain messages, interact with other avatar bots or avatars controlled by real-world users, etc. Still further, the bots can be set to interact in defined manners, modify environments, post advertising, post messages, build virtual spaces, virtual buildings, or construct virtual objects, graphical representations of objects, exchange real or virtual money, etc.

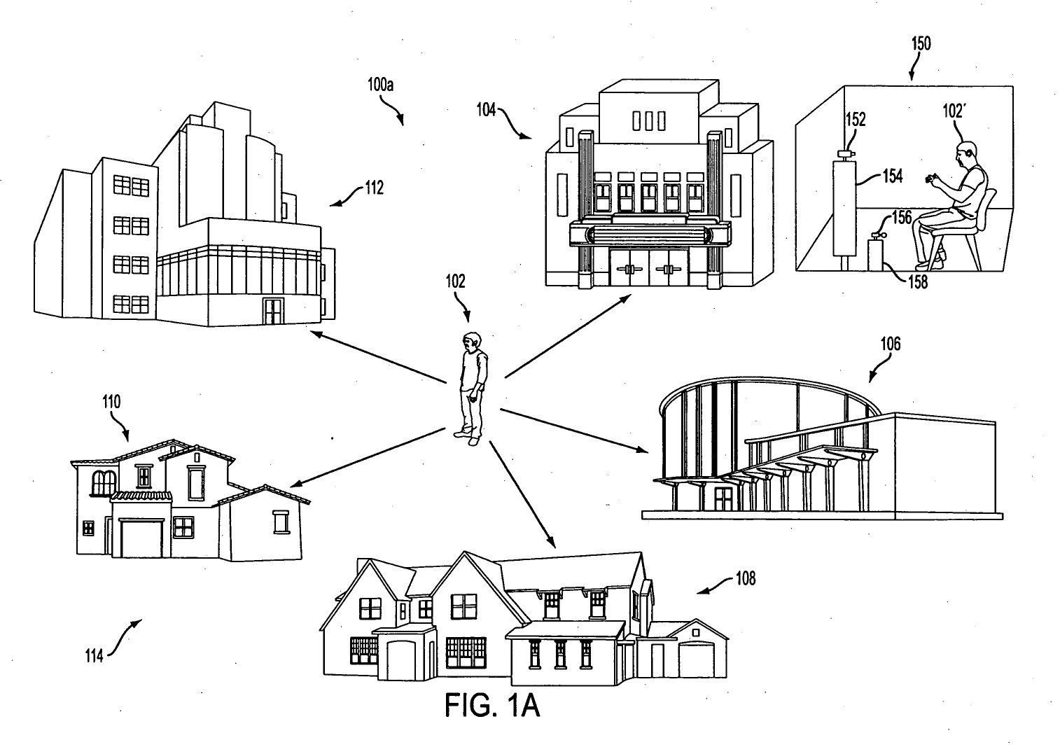

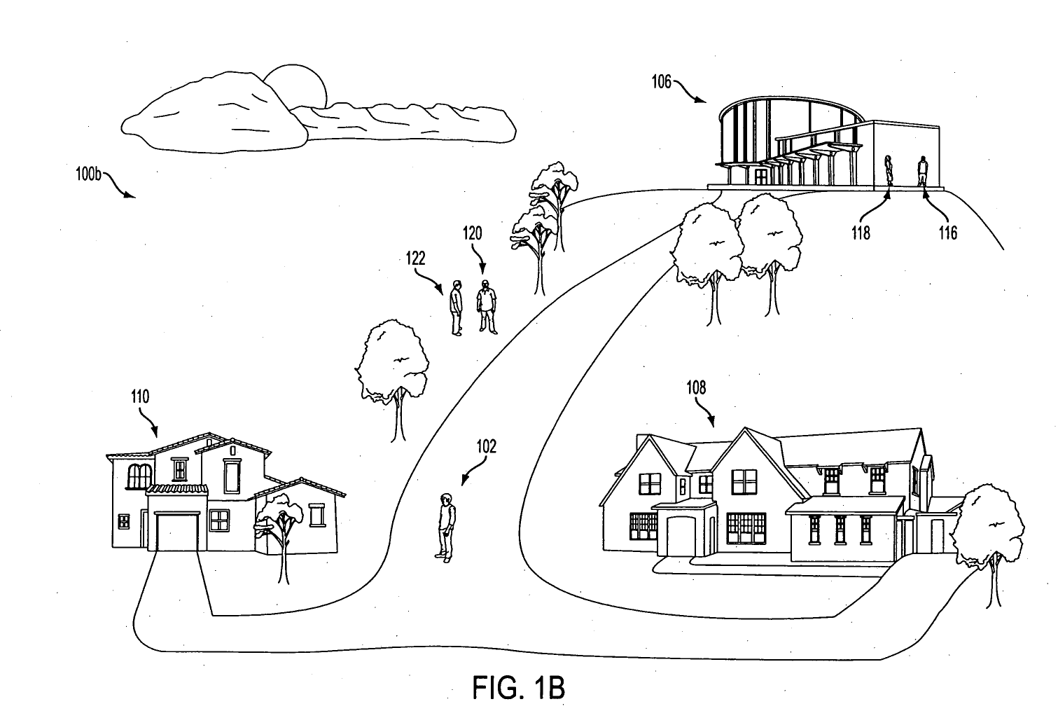

FIG. 1A illustrates a graphic diagram of a conceptual virtual space 100a, in accordance with one embodiment of the present invention. A user of an interactive game may be represented as an avatar on the display screen to illustrate the user's representation in the conceptual virtual space 100a. For example purposes, the user of a video game may be user A 102. User A 102 is free to roam around the conceptual virtual space 100a so as to visit different spaces within the virtual space. In the example illustrated, user A 102 may freely travel to a theater 104, a meeting space 106, user A home 110, user B home 108, or an outdoor space 114. Again, these spaces are similar to the spaces real people may visit in their real-world environment.

Moving the avatar representation of user A 102 about the conceptual virtual space 100a can be dictated by a real-world user 102′ moving a controller of a game console 158 and dictating movements of the avatar in different directions so as to virtually enter the various spaces of the conceptual virtual space 100a. The location 150 of the real-world user may be anywhere the user has access to a device that has access to the internet. In the example shown, the real-world user 102′ is viewing a display 154. A game system may also include a camera 152 for capturing reactions of the real-world user 102′ and a microphone 156 for observing sounds of the real-world user 102′. For more information on controlling avatar movement, reference may be made to U.S. patent application Ser. No. ______ (Attorney Docket No. SONYP066), entitled “Interactive user controlled avatar animations”, filed on the same day as the instant application and assigned to the same assignee, is herein incorporated by reference. Reference may also be made to: (1) United Kingdom patent application no. 0703974.6 entitled “ENTERTAINMENT DEVICE”, filed on Mar. 1, 2007; (2) United Kingdom patent application no. 0704225.2 entitled “ENTERTAINMENT DEVICE AND METHOD”, filed on Mar. 5, 2007; (3) United Kingdom patent application no. 0704235.1 entitled “ENTERTAINMENT DEVICE AND METHOD”, filed on Mar. 5, 2007; (4) United Kingdom patent application no. 0704227.8 entitled “ENTERTAINMENT DEVICE AND METHOD”, filed on Mar. 5, 2007; and (5) United Kingdom patent application no. 0704246.8 entitled “ENTERTAINMENT DEVICE AND METHOD”, filed on Mar. 5, 2007, each of which is herein incorporated by reference.

FIG. 1B illustrates a virtual space 100b, defining additional detail of a virtual world in which user A may move around and interact with other users, objects, or communicate with other users or objects, in accordance with one embodiment of the present invention. As illustrated, user A 102 may have a user A home 110 in which user A 102 may enter, store things, label things, interact with things, meet other users, exchange opinions, or simply define as a home base for user A 102. User A 102 may travel in the virtual space 100b in any number of ways. One example may be to have user A 102 walk around the virtual space 100b so as to enter into or out of different spaces.

For example, user A 102 may walk over to user B home 108. Once at user B home 108, user A 102 can knock on the door, and seek entrance into the home of user B108. Depending on whether user A 102 has access to the home of user B, the home may remain closed to user A102. Additionally, user B116 (e.g., as controlled by a real-world users) may walk around the virtual space 100b and enter into or out of different spaces. User B116 is currently shown in FIG. 1B as standing outside of meeting place 106. User B116 is shown talking to user C118 at meeting space 106. In virtual space 100b, user D120 is shown talking to user E122 in a common area. The virtual space 100b is shown to have various space conditions such as weather, roadways, trees, shrubs, and other aesthetic and interactive features to allow the various users to roam around, enter and exit different spaces for interactivity, define communication, leave notes for other users, or simply interact within virtual space 100b.

In one embodiment, user A102 may interact with other users shown in the virtual space 100b. In other examples, the various users illustrated within the virtual space 100b may not actually be tied to a real-world user, and may simply be provided by the computer system and game program to illustrate activity and popularity of particular spaces within the virtual space 100b.

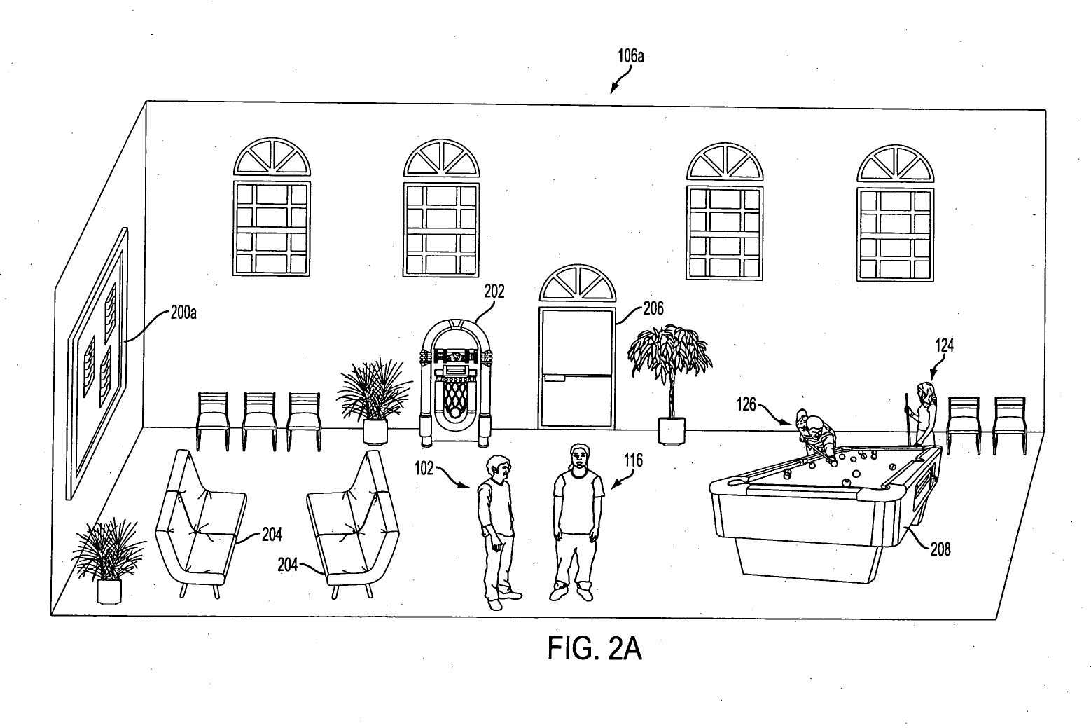

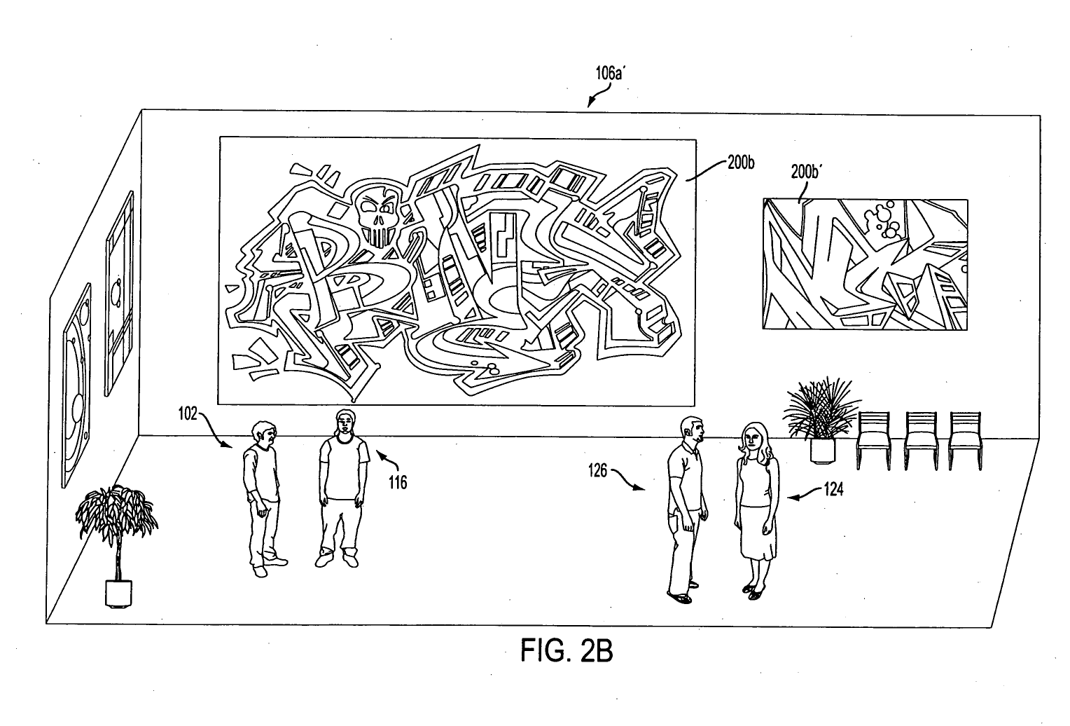

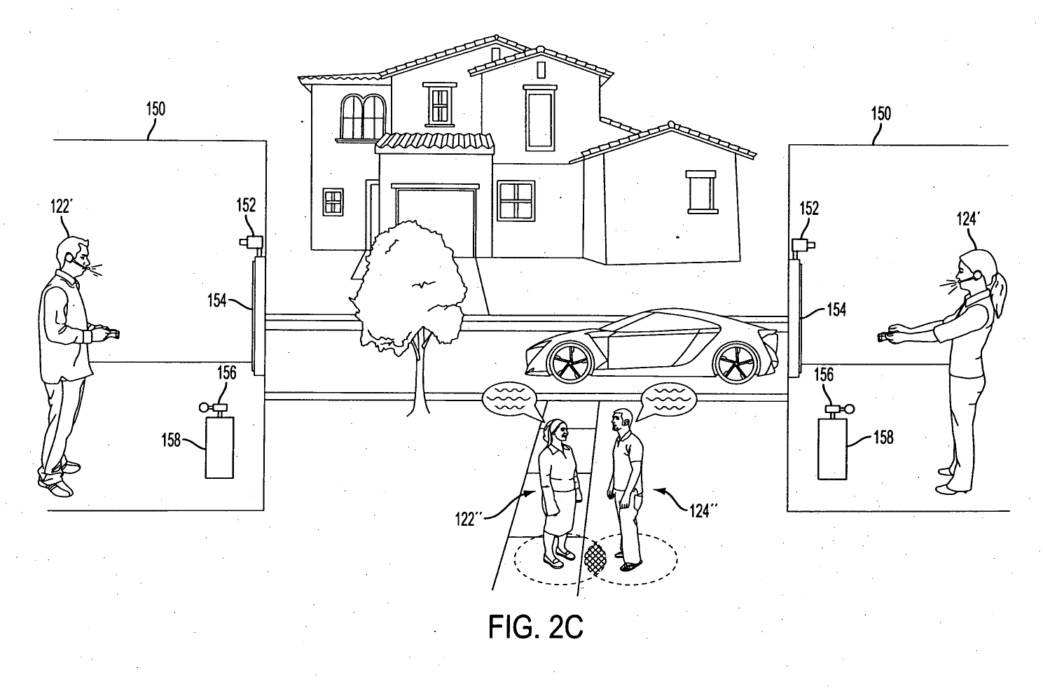

FIG. 2A illustrates a meeting space 106a in which user A102 and user B116 are shown having a conversation. In one embodiment, user A102 may be speaking to user B116 if user A102 is sufficiently close to user B116. User A₁₀₂ may also choose to move around the meeting space 106a and communicate with other users, such as user G126, user F124, and interact with the various objects within the meeting space 106a. In a further example, user A102 may walk over to a juke box 202 and select particular songs in the juke box so that other avatars (that may be controlled by real-world users) can also listen to a song within the meeting space. Selection of particular songs may be monitored, so that producers of those songs can then market/advertise their albums, songs or merchandise to such real-world users. Monitoring avatar activity is, in one embodiment, full of rich information that can be stored, accessed and shared with advertisers, owners of products, or network environment creators.

In one embodiment, user A102, user B116, user F124, and user G126 may walk around the meeting space 106a and interact with the objects such as pool table 208, seating 204, and an interactive space 200a. As will be described below, the interactive space 200a is provided in the meeting space 106a to enable users to communicate with each other within the meeting space 106a. The interactive space 200a, in this example, is illustrated as a message board that would allow different users to post different messages on the interactive space 200a. Depending on whether the users have privileges to view the messages posted on the interactive space 200a, only particular users will be granted access to view the messages posted in the interactive space 200a. If users do not have access to view specific messages posted on the interactive space 200a, those users will not be able to see the messages or the messages may be in a blurred state. Further details regarding the posting of messages, e.g., similar to posting real-world Post-it™ notes on a wall with messages, will be discussed below in more detail.

FIG. 2B illustrates another meeting place 106a′ where user A102, user B116, user G126, and user F124, have decided to enter and interact. In one embodiment, as users enter meeting space 106a′, users may view particular postings, messages, or information that may be placed on interactive spaces 200b, or 200b′. Although the messages posted on interactive spaces 200b and 200b′ may appear to be messy artwork, when specific users have privileges to view the interactive spaces 200b and 200b′, the users can view specific data. Thus, the messy postings may become clear and more understandable to the users having privileges to filter out non-applicable information from the mess that is found on the interactive spaces within the meeting space 106a′. One meeting space is shown, but many meeting spaces may be provided throughout the virtual world, and the interactive spaces can take on may forms, not just limited to posting boards.

Interaction between the users, in one embodiment, may be tracked, and interfaced by allowing real-world users to speak into a microphone at a game console or controller, and such voice is communicated to the specific users with which other users feel a desire to communicate with. For example, when user A102 and user B116 come in close proximity to one another within the meeting space 106a′, communication may be desired and enabled (or refused). However, communications occurring between user G126 and user F124 may not readily be understood or heard by user A and user B. In some embodiments, other conversations may be heard as background noise, to signal a crowded room of activity.

In one embodiment, in order to have a conversation with specific avatars within the meeting space, the avatars controlled by the specific real-world users should be moved in close proximity to the target avatar so as to have a conversation and enable and trigger the beginning of a conversation.

FIG. 2C illustrates an example where a virtual space is provided for the avatars that include user E 122″ and user F 124″, in this example. The controllers of the various avatars may be real-world users, such as user 122′ and user 124′. User 122′ in the real-world may wear a headset to allow the user to interact with other users when their avatars approach a region where their zone of interest is similar.

For instance, when user 122″ and user 124″ in the virtual space approach one another, an overlap (hatched) of their zone of interactivity is detected which would allow the real-world user 122′ and the real-world user 124′ to strike up a conversation and suggest game play with one another or simply hangout. As illustrated, the real-world users may not necessarily look like the virtual space avatar users and in fact, the virtual space avatar users may not even match in gender, but can be controlled and interacted with as if they were real-world users within the virtual space 100b. As shown, user 122′ and user 124′ in the real-world may be positioned in their own home entertainment area or area 150 where they are in contact or communication with a game console 158 and a controller, to control their avatars through out the virtual space. Each real-world user, in this example, is also shown viewing a display 154. Optionally, each real-world user may interact with a camera 152 and a microphone 156.

The controller may be used in communication with the game console and the users in the real-world may view a television screen or display screen that projects an image of the virtual space from their perspective, in relation to where the head of their avatar is looking. In this manner, the real-world user can walk about the virtual space and find users to interact with, post messages, and hold discussions with one or more virtual avatar users in the virtual space.

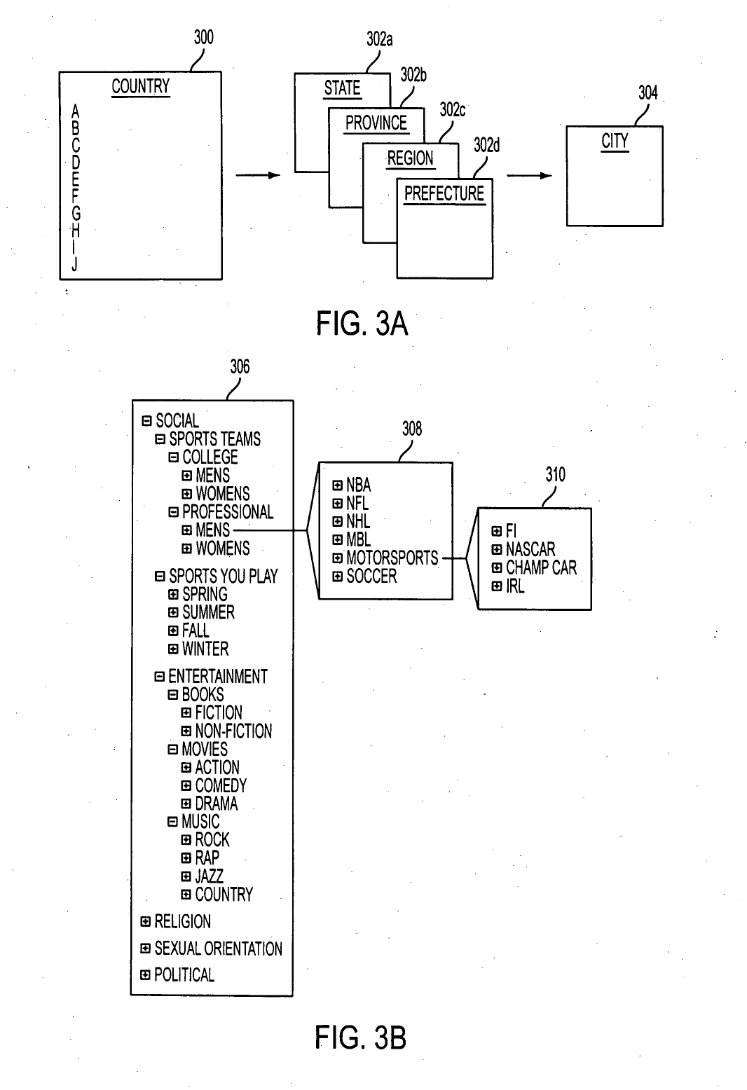

FIG. 3A illustrates a location profile for an avatar that is associated with a user of a game in which virtual space interactivity is provided. In order to narrow down the location in which the user wishes to interact, a selection menu is provided to allow the user to select a profile that will better define the user's interests and the types of locations and spaces that may be available to the user. For example, the user may be provided with a location menu 300. Location menu 300 may be provided with a directory of countries that may be itemized by alphabetical order.

The user would then select a particular country, such as Japan, and the user would then be provided a location sub-menu 302. Location sub-menu 302 may ask the user to define a state 302a, a province 302b, a region 302c, or a prefecture 302d, depending on the location selected. If the country that was selected was Japan, Japan is divided into prefectures 302d, that represent a type of state within the country of Japan. Then, the user would be provided with a selection of cities 304.

Once the user has selected a particular city within a prefecture, such as Tokyo, Japan, the user would be provided with further menus to zero down into locations and virtual spaces that may be applicable to the user. FIG. 3B illustrates a personal profile for the user and the avatar that would be representing the user in the virtual space. In this example, a personal profile menu 306 is provided. The personal profile menu 306 will list a plurality of options for the user to select based on the types of social definitions associated with the personal profile defined by the user. For example, the social profile may include sports teams, sports e-play, entertainment, and other sub-categories within the social selection criteria. Further shown is a sub-menu 308 that may be selected when a user selects a professional men's sports team, and additional sub-menus 310 that may define further aspects of motor sports.

Further illustrated are examples to allow a user to select a religion, sexual orientation, or political preference. The examples illustrated in the personal profile menu 306 are only exemplary, and it should be understood that the granularity and that variations in profile selection menu contents may change depending on the country selected for the user using the location menu 300 of FIG. 3A, the sub-menus 302, and the city selector 304. In one embodiment, certain categories may be partially or completely filled based on the location profile defined by the user. For example, the Japanese location selection could load a plurality of baseball teams in the sports section that may include Japanese league teams (e.g., Nippon Baseball League) as opposed to U.S. based Major League Baseball (MLB™) teams.

Similarly, other categories such as local religions, politics, politicians, may be partially generated in the personal profile selection menu 306 based on the users prior location selection in FIG. 3A. Accordingly, the personal profile menu 306 is a dynamic menu that is generated and is displayed to the user with specific reference to the selections of the user in relation to the where the user is located on the planet. Once the avatar selections have been made for the location profile in FIG. 3A and the personal profile in FIG. 3B, the user controlling his or her avatar can roam around, visit, enter, and interact with objects and people within the virtual world. In addition to visiting real-world counter-parts in the virtual world, it is also possible that categories of make belief worlds can be visited. Thus, profiles and selections may be for any form, type, world, or preference, and the example profile selector shall not limit the possibilities in profiles or selections.

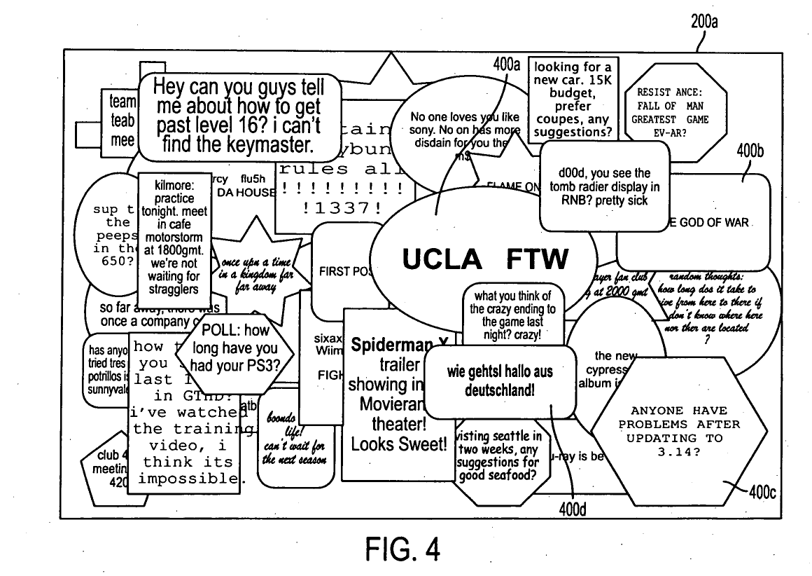

FIG. 4 illustrates an interactive space 200a, in accordance with one embodiment of the present invention. Interactive space 200a will appear to be a messy conglomeration of messages posted by various users during a particular point in time. The interactive space is illustrated without any filtering of messages and would appear to be disjointed, messy, and incomprehensible to a general user. Once a user avatar approaches the interactive space 200a, the user will see a plurality of messages such as general discussions 400a, discussions based on games 400b, discussion related to software updates, discussions in various languages 400d, and so on. In other embodiments, the interactive space 200a may appear fuzzy, or semi-visible to the user. Further examples will be provided with reference to the following figures.

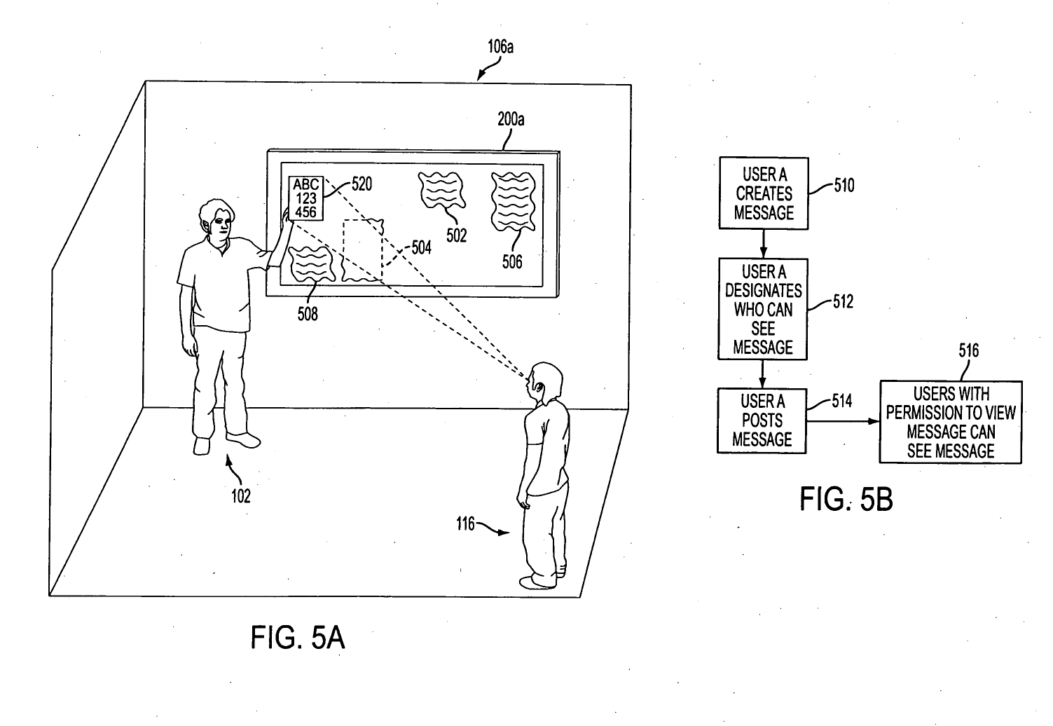

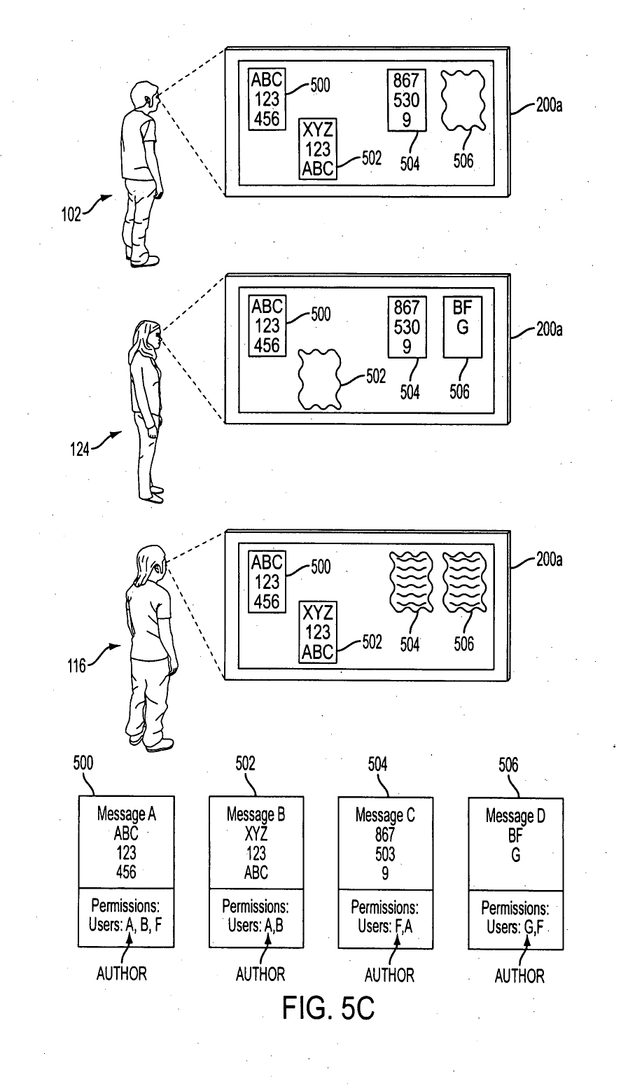

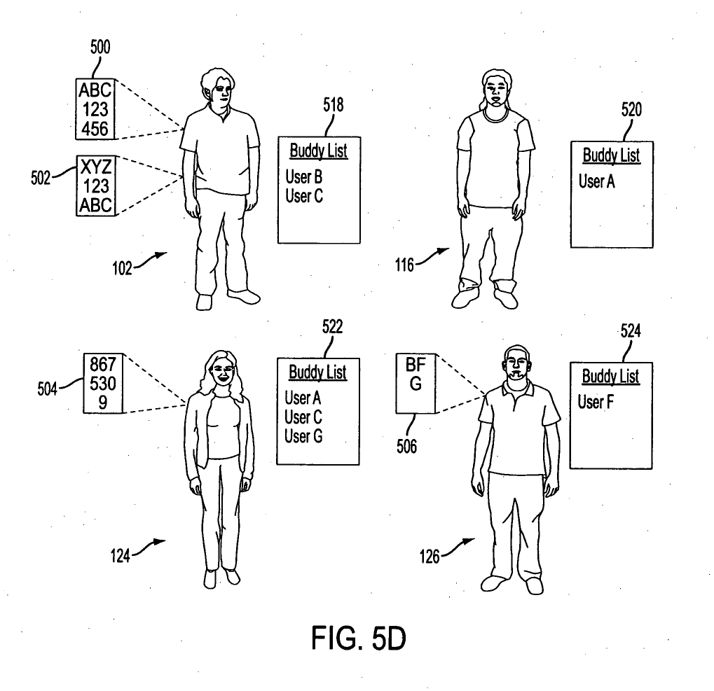

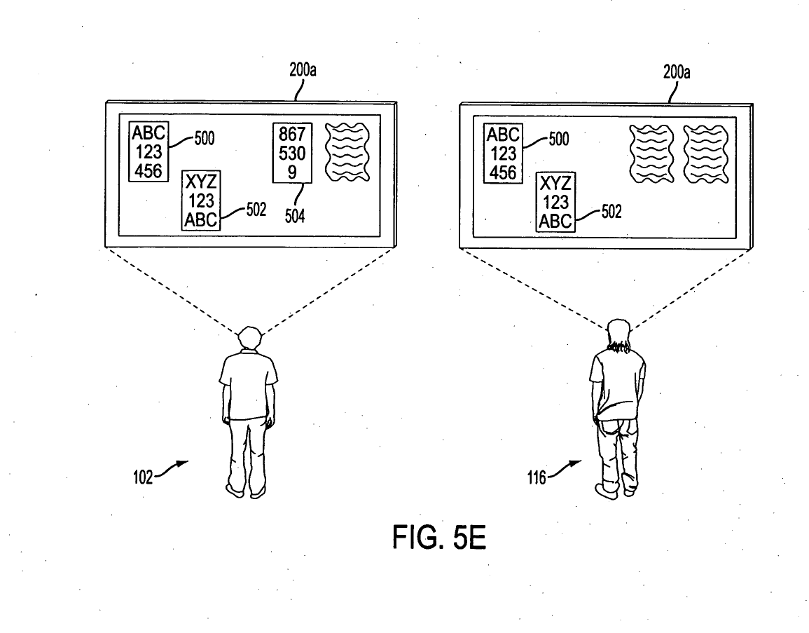

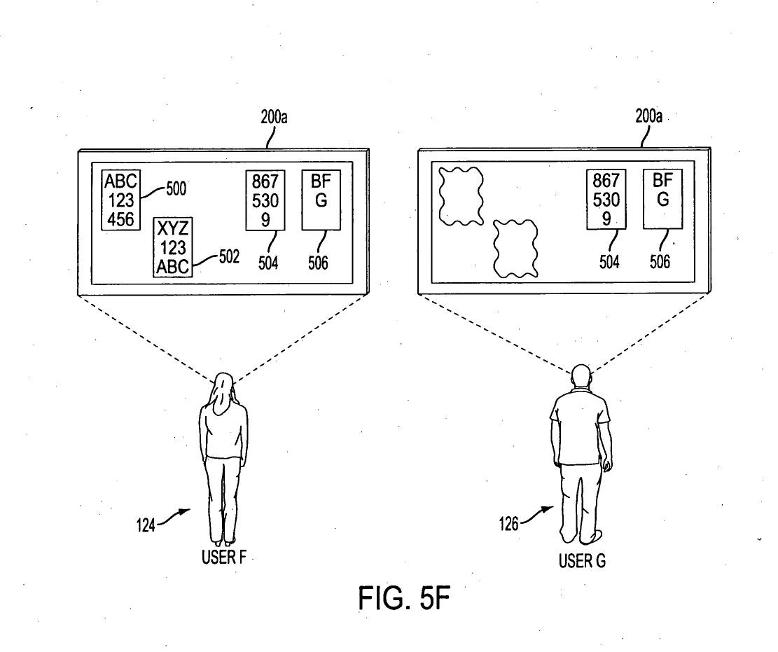

FIG. 5A illustrates a meeting space 106a having an interactive space 200a. Interactive space 200a is illustrated as a message board at which users can post messages to allow other users to read such messages depending on their permissions or privileges or associations with the user posting the messages. In the illustrated example, user A102 is posting a message A500 on the interactive space 200a. Message A is shown to include a message ABC123456.

User B116 viewing the interactive space 200a will be able to see certain messages such as message A because user B has permissions from user A to view the messages that where posted on the interactive space 200a. Filtering out messages that are not viewable to the user or appear to be incomprehensible scribbles may also be posted on the interactive space 200a. The user B116 viewing other messages on the interactive space 200a may not be able to view or understand those other messages. For instance, message B502, message D506, and message E508 may be posted on the interactive space 200a, but when viewed by user B116, the user will only see a scribble or an image of what a message might be had the user been given permissions to view those messages by the users that posted the messages in the first place.

In other examples, messages may be posted on the interactive space 200a and the permissions may allow all users to view the messages. In such circumstances, additional filtering may be desired by the user actually viewing the message board to only view certain messages when the message board is too cluttered or incomprehensible.

Still further, messages on the interactive space 200a, such as message C504 may not be viewable at all if the user B116 has even less permissions to view secret messages posted on the interactive space 200a. Thus, the interactive space 200a will have a number of messages where some of the messages are visible to all users some visible to only selective users, and the representation of whether they are viewable or not may depend on the settings dictated by the users posting on the interactive space 200a.

Again, it is shown in FIG. 5A that user 102 is posting message A onto the interactive space 200a. FIG. 5B illustrates a flow diagram identifying operations that may be performed by computing systems to enable the interactive space functionality and interaction by and from the users in the meeting space 106a.

The flow of FIG. 5B illustrates operation 510 where user A creates a message. User A102 is shown creating a message and posting the message in FIG. 5A. In operation 512, user A designates message permissions that would be tagged and associated to the message being posted on the interactive space 200a. Operation 514 defines the operations of allowing user A to post a message onto the interactive space 200a. Posting of the message may include having the user walk up to the interactive space 200a and place the message in a desired location.

Defined controller commands may designate the act of creating a new message, which may be keyed into a keyboard, controller or dictated in voice commands and then the generation of the message item that would then be displayed and posted onto the interactive space 200a. In operation 516, users with permissions to view the message can see the message on the interactive space 200a. Users that do not have permissions to view the message will not be able to view the message as described above.

FIG. 5C illustrates views of the interactive space with message permissions defined by author of the message, in accordance with one embodiment of the present invention. Viewing from top to bottom, user A102 is shown viewing the interactive space 200a. User A is the author of message A500 and message B502. Message C504 is also viewable to user A102 because the author of message C, which is user F designated user A as having permissions to view message C. Message D506 appears as a non-viewable item to user A102 on the interactive space 200a. Message D506 was authored by user G, but user G did not provide permissions to user A to view message D. Message D, as authored by user G allows user F permissions to view message D506.

Thus, user F is allowed to view message D as shown in the middle illustration of user F viewing the interactive space 200a. User F124 is also granted viewing access to message A500 and message C504. Message A, as authored by user A allows user F permissions to view message A. Message C, authored by user F, the same user viewing the interactive space 200a in the middle illustration is also granted access to view her message, as she generated that message. Message D, as authored by user G granted user F viewing access to the interactive space to view message D. In the final illustration, user B116 is shown viewing the interactive space.

User B116 is able to view message A and message B because user A granted user B access to view message A, and user A also granted user B access to view message B. However, user B116 is not provided with access to view message C and message D, as the authors of message C and message D did not grant user B116 access to view that particular message. In one embodiment, user B116 may be a buddy of user A, and thus user A may grant user B access to view particular messages posted on the interactive space 200a.

FIG. 5D illustrates examples where a buddy list determines message permissions granted to particular users and their avatars that may be entering and exiting specific places within the virtual space. In this example, user A102 is in the top left-hand corner, user B116 is in the top right-hand corner, user F124 is in the bottom left-hand corner, and user G126 is in the bottom right-hand corner. In this example, each of the users has a particular buddy list shown as buddy lists 518, 520, 522 and 524. Also illustrated are the messages composed by each of the users.

User A102 composed message 500 and 502, while user F composed message C504 and user G composed message D506. In this example, the messages are associated with the particulars authors, and a determination of who is allowed to view the particular messages may be dictated by who is on the particular buddies list. Additionally, users may provide different users within a buddy list different privileges to view specific messages. Some message may be more confidential and may not be allowed to be viewed by all buddies on a list but other messages are more generic and all buddies within a list would be granted access to the specific messages posted on the interactive space 200a.

FIG. 5E illustrates an example where user A102 and user B116 are viewing the interactive spaces 200a. In the example, user A102 is allowed to view messages 550, 502, and 504 because user A is on the buddy lists of user B and user F. In this example user F created message C and therefore user A102 can view message C as well as message A and message B, which were created by user A102. User B116 is viewing the interactive space and is allowed to view message A and message B because user B116 is on the buddy list of user A. However, user B116 is not on the buddy lists of other users and thus is only allowed access to those messages that are on the buddy lists associated with his permission.

FIG. 5F illustrates yet another example where user F124 viewing the interactive space is able to view message A, message B, message C and message D because user F is a popular user that might be on more buddy lists. User G, is provided with access to view message C and message D. User G is not provided with access to view other message because user G is only a limited set of buddy lists.

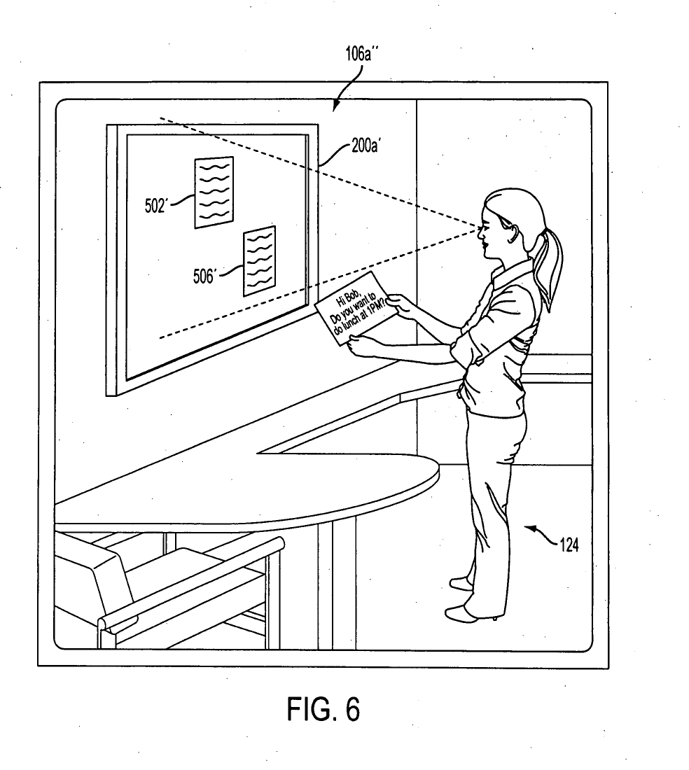

FIG. 6 illustrates an alternative view of the interactive space 200a′ which may be part of a meeting space 106a″. In this example, user F124 may compose a note or message that is about to be placed onto the interactive space 200a′. In this example, the note being placed by user F124 may read, “Hi Bob, Do you want to do lunch at 1 PM?” User F124 can then reach over to the interactive space 200a′ and post a message onto the message board. Again user F124 may be an avatar that is representative of a user who is entering the meeting space 106a″ and the user using a control of a game console can maneuver user F124 (in an avatar sense) around the meeting space 106a″ so as to compose messages, and virtually post the messages onto the interactive space 200a′.

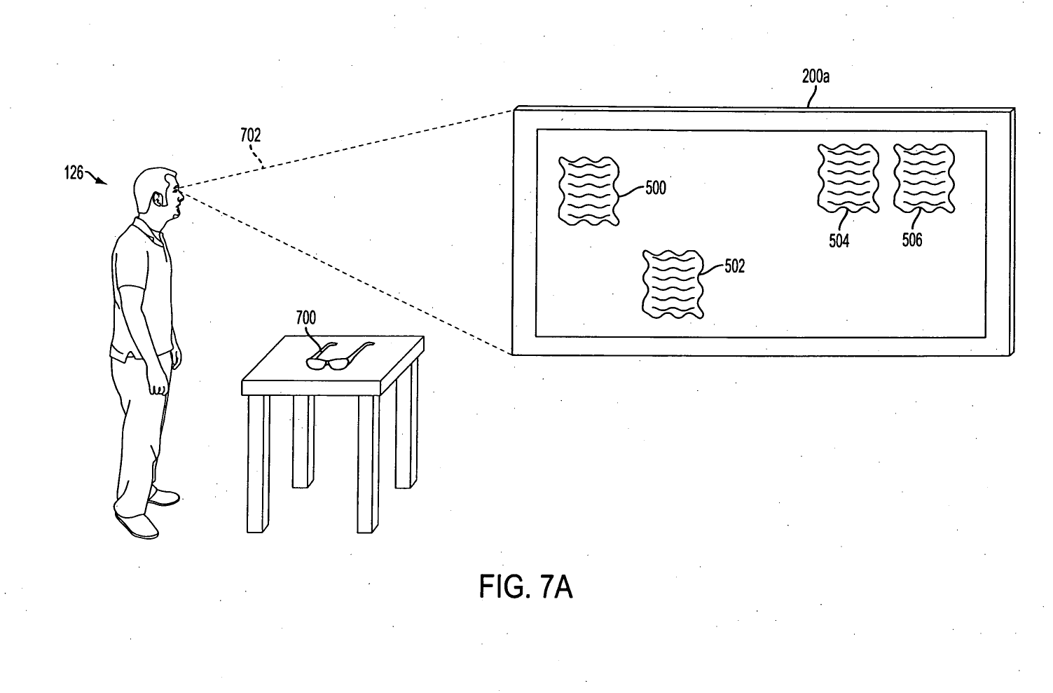

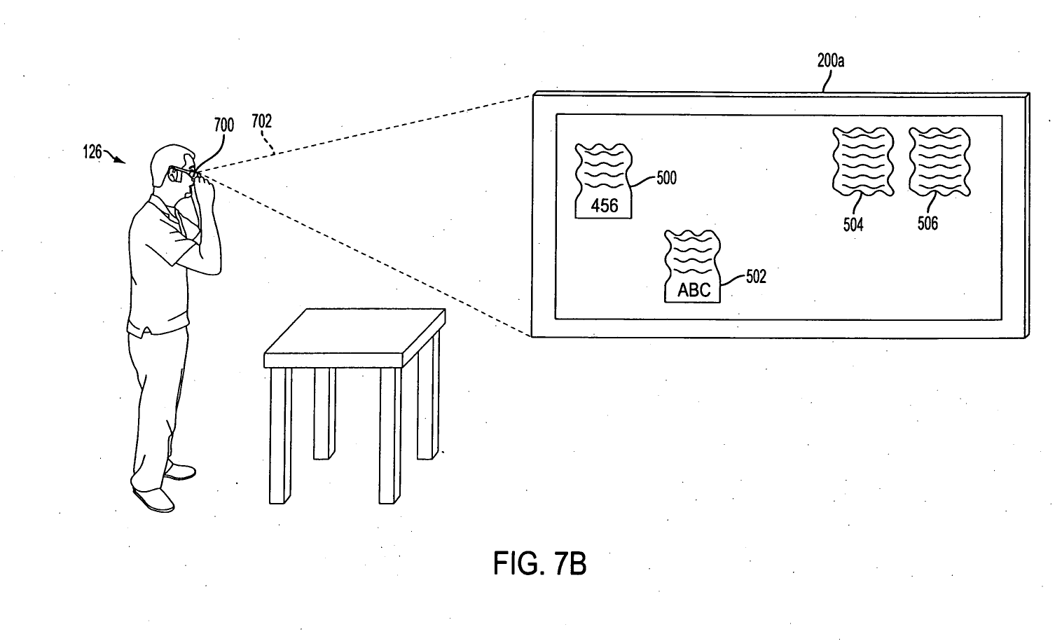

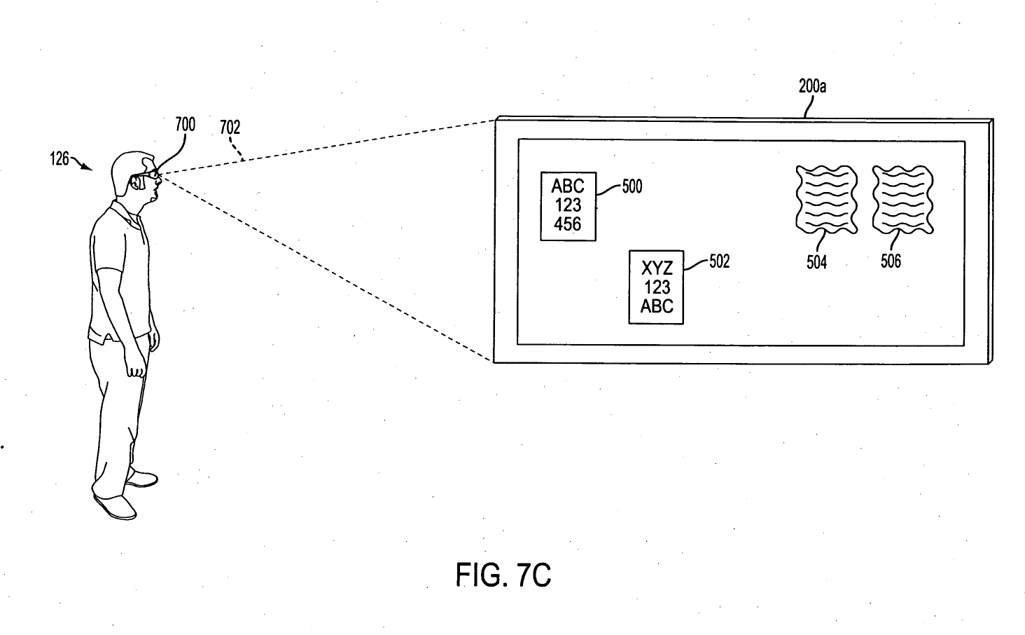

FIG. 7A illustrates another example in which user G126 is viewing the interactive space 200a. In this embodiment, user G126 may be provided with the capability of applying a view filter 700 onto his virtual face so as to view the interactive space 200a and determine whether certain messages are viewable to user G126. The view filter 700 is illustrated as a pair of glasses which are virtually provided in the room where user G enters so as to allow user G to filter out or clearly view the interactive space postings (e.g., messages). In one embodiment, user G126 can obtain view filter 700 from a location that is proximate and within the space where the interactive space 200a resides, or the user can obtain glasses from a store within the virtual world and such glasses having different capabilities could be purchased or obtained to allow viewing of more or less content. And still another embodiment, all users are provided with filters in the form of glasses that can be carried along with the particular user avatars and used when needed to filter out content if too much content is provided in the particular spaces.

Still further, the view filter 700 could be provided so that different types of view filters provide different levels of access and higher or lower levels of access are granted to the users depending on their skill level, skill set or interactivity within the virtual space. And still another embodiment, users may obtain or share view filters 700 between each other depending on trust level or their desire to allow a buddy that they encounter in the virtual world to view certain data, information, or messages.

FIG. 7B illustrates user G126 placing the view filter 700 (e.g., glasses) onto his face and looking towards the interactive space 200a. As the user places the glasses onto his face, the messages 502 and 500 start to come into focus because the view filter 700 would allow user G126 to view message A and B. In FIG. 7C, user G126, focusing on the field of view 702 is able to fully view the messages 500 and 502 (messages A and B) placed on the interactive space 200a. However, the view filter 700 still does not allow user G126 to view other messages, such as messages C and D.

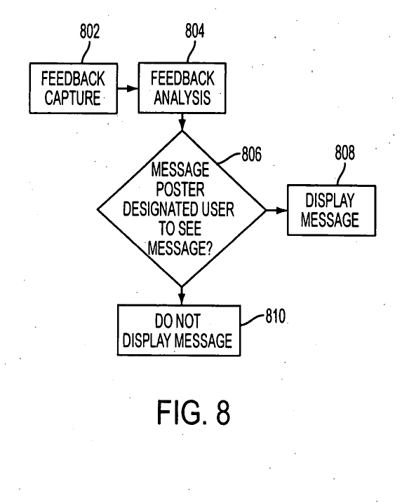

FIG. 8 illustrates a flow diagram to defining the process that would allow or disallow users to view certain information, such as messages, that may be posted on boards within the virtual space or location being traveled by an avatar. In this example, operation 802 defines a feedback capture that is designed to determine whether an avatar user is wearing particular view filter 700, or has permissions to view specific messages that may be posted on an interactive space 200a.

Thus, referring to FIG. 7C, if user G126 is wearing the view filter 700, the feedback capture operation 802 determines that the user is wearing the virtual glasses and that information is provided to analysis operation 804 that is then processed to determine whether a message poster designated the user to see the message in decision block 806. For instances, if the users that posted the messages on the interactive space 200a determined that user G126 was allowed to view those messages, then those authors of the messages were the message posters and they were the ones that designated whether specific users where able to view those specific messages. Once this determination has been made in operation 806, the process moves to either display the message in operation 808, or not display the message in operation 810.

If the message is displayed in operation 808, FIG. 7C would illustrate message A and message B fully viewable to user G126. However, if user G126 was not designated by the message poster to have access to that specific message, operation 810 would blur the messages as shown by messages C and D in FIG. 7C.

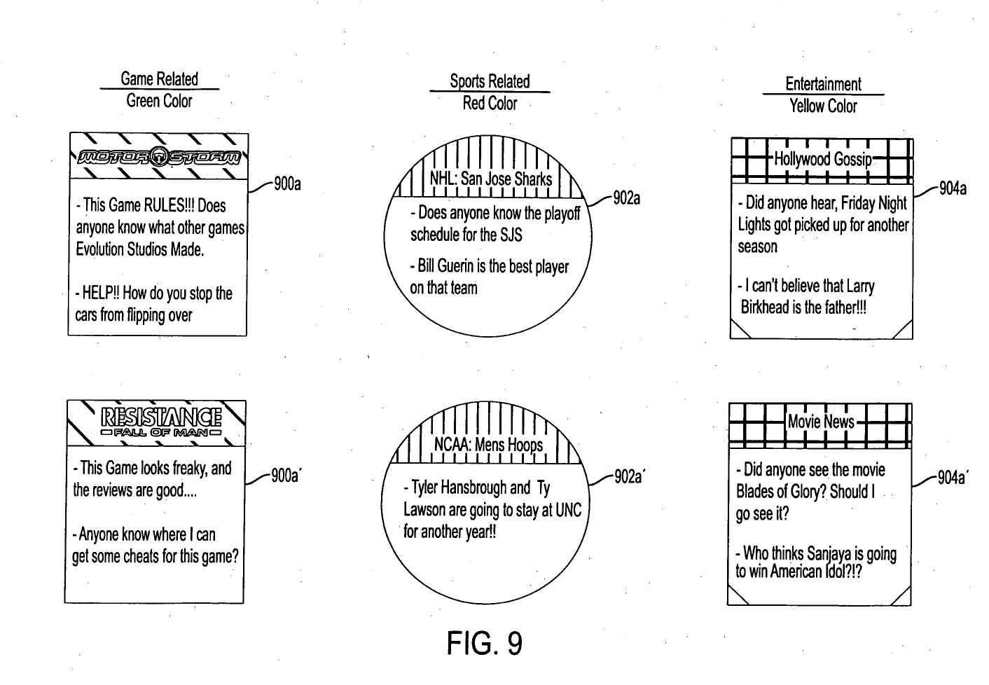

FIG. 9 illustrates an embodiment where posted messages composed by users can take on different shapes, sizes, and colors to distinguish them from other posted messages that may be applied to an interactive space in the various virtual spaces that users may travel, in accordance with one embodiment of the present invention. As illustrated, message 900a and 900a′ may take on a green color to signify that these messages relate to game related information.

Additionally, messages may be composed with header information using logos or names of video games so that interested users can quickly identify messages as relating to games which they also have an interest. The example of messages 902a and 902a′ illustrate sports related messages, which may also include color identifiers (e.g., red) to further distinguish the sports related messages from other messages. As noted above, messages posted on an interactive space, or on objects, or other users may be become cluttered due to user message activity, and thus identifying shapes and colors will assist in distinguishing the various messages from one another.

Continuing with the example, entertainment related messages may take on yet a different color e.g., yellow. In this example, messages 904a and 904a′ may relate to entertainment, gossip and news. The size, shape, or other distinguishing marks on the messages will assist users to quickly identify messages that are of interest and may allow users to comment on the messages, or simply view and post related message in response to posted messages.

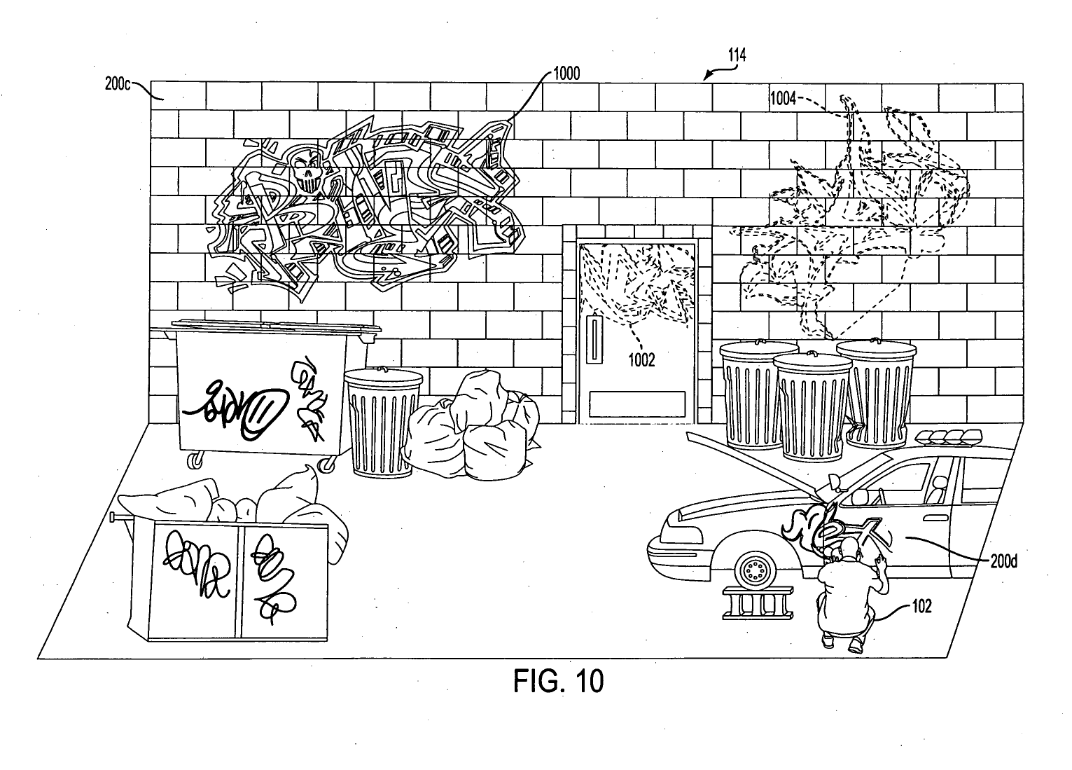

FIG. 10 illustrates an interactive space 200c which may be defined by a building that is part of the conceptual virtual space environment, in accordance with one embodiment of the present invention. Thus, it should be understood that the interactive spaces within the conceptual virtual space 100a is not restricted to a bulletin board, but shall include any object, wall, building, person, or feature of a meeting space, building space, outdoor space, and the like. In the illustration of FIG. 10, user A102 is shown applying graffiti notes onto a vehicle which will serve to be an interactive space 200d. Interactive space 200c has also been used by other users to apply their own graffiti, messages or notes.

Example graffiti may include 1000, 1002, and 1004. Depending on the privileges and permissions provided to the various users, only certain graffiti, notes, or artwork will be visible to the specific users. In this example, user 102 is not able to see graffiti messages 1002 and 1004. However, other users that may enter the interactive space 114, which may be outdoor public space, will be able to view the various graffiti notes, or messages. Furthermore, the virtual space 114 may also be used to receive messages such as the ones described with reference to FIG. 9, or other messages described above.

Thus, users are provided with the capability of expressing their creativity in various ways so that users (e.g., buddies) that enter these public spaces or private spaces will be able to view, share, and comment on the various graphics or messages that express the creativity or express a communication signal (e.g., spray paint tag, etc.) to the other users.

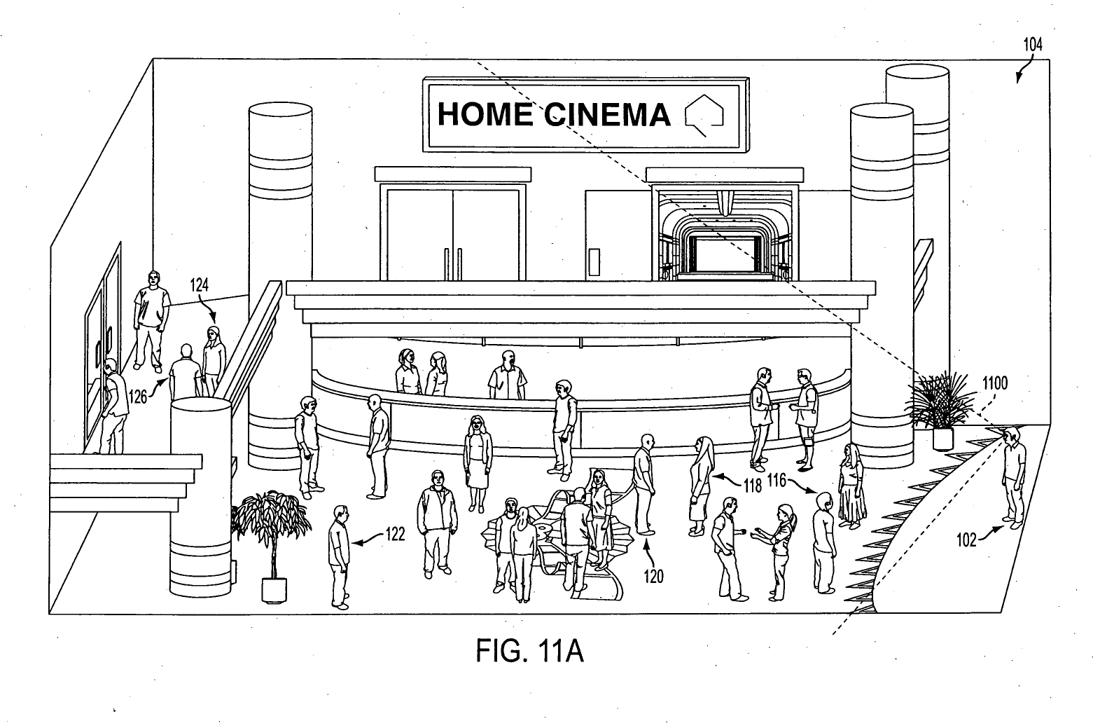

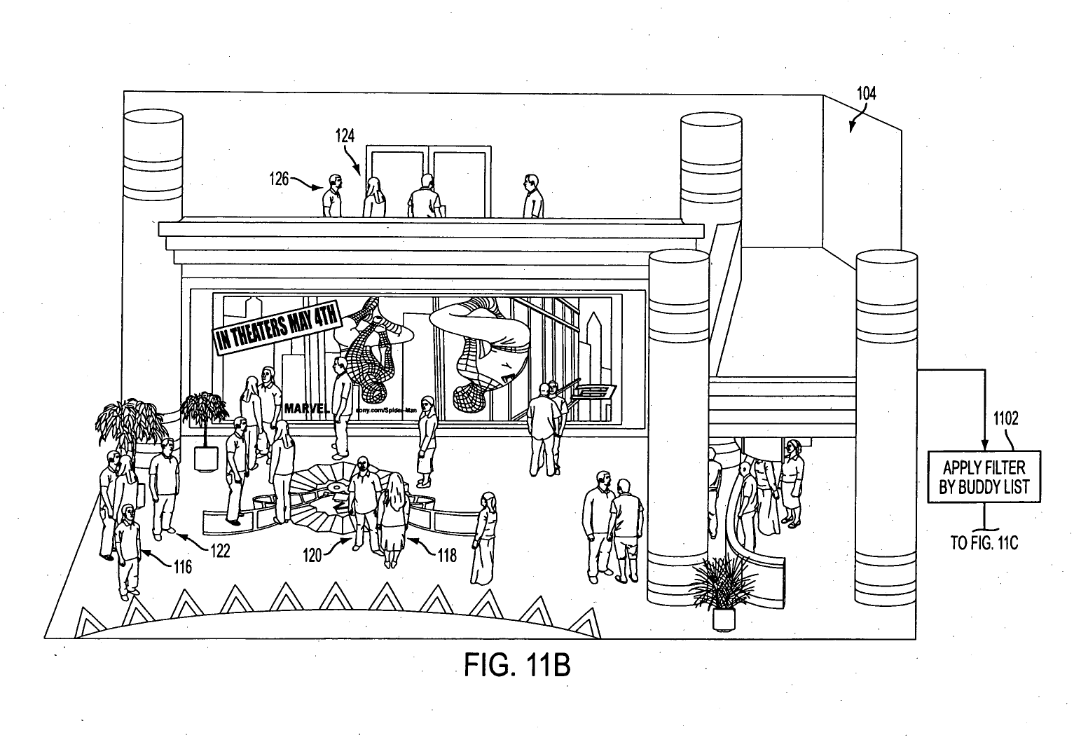

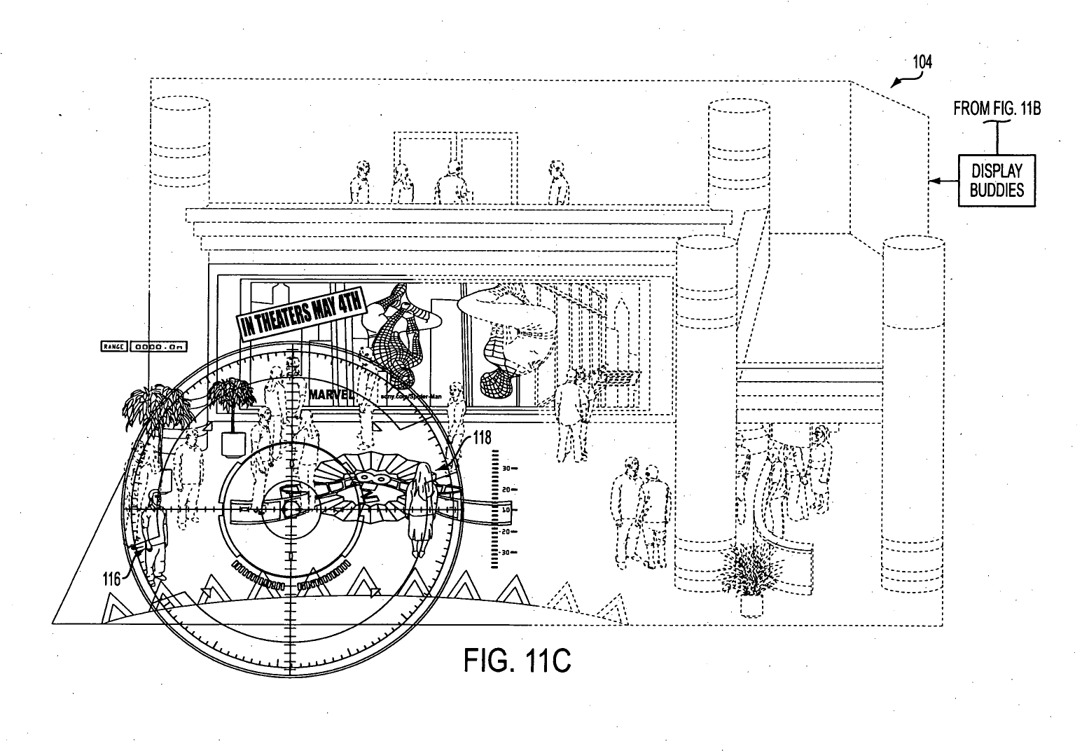

FIG. 11A illustrates a cinema space 104 where it plurality of virtual avatar users are congregating, meeting, and interacting, in accordance with one embodiment of the present invention. As shown, the cinema space 104 is a popular place to visit in the virtual space, and many users are roaming about this space, having conversations, and generally interacting. In this example, user A102 has a field of view 1100, and his perspective of the cinema space 104 is from his field of view 1100. If user A102 moves his head or moves about the room, his field of view 1100 will change and the various objects, architecture, and users will also change depending on the set field of view 1100.

Because the cinema space 104 is a crowded and popular place, user A102 may find it difficult to identify buddies that may be hanging out in the cinema space 104. FIG. 11B illustrates the field of view 1100 from the perspective of user A102. As can be seen, different visual perspectives provide a dynamically changing environment that can be traveled, interacted with, and visited by the various users that enter the virtual space. In one embodiment, operations are performed to apply a filter that is dependent on a buddy list. The filter operation 1102, when applied will illustrate the embodiment of FIG. 11C. In FIG. 11C, a scope is provided that will focus user A102 on a particular region within the cinema space 104. The scope will identify users hanging out in the cinema space 104 that may belong to his buddy list.

With reference to FIG. 5D, user A102 has a buddy list 518 that includes user B and user C. In FIG. 11C, user B116 and user C118 will define the focus of the scope within the cinema space 104. Scoping out your buddies is a useful tool that can be triggered using a controller command button, voice command, or other interactive selection commands. Once the selection command triggers the identification of your buddies within the cinema space 104, the scope identifies those buddies within the specific room. Other aspects of the cinema space 104, including other users that may be visiting the same space may be grayed out, or their focus may be blurred so that the user can quickly focus in on the location of his or her buddies. Although a scope is provided to identify where the buddies are within the cinema space 104, other identifying graphics can be provided to quickly identify those buddies within a room.

Alternative examples may include highlighting your buddies with a different color, applying a flickering color in or around your buddy, or defocusing all other users within a specific room. Consequently, the operation of a applying a filter based on a buddy list should be broadly understood to encompass a number of identifying operations that allow users to quickly zone in to their buddies (or persons/things of interest) so that the user can approach their buddies to have a conversation, interact with, or hangout in the virtue space 104.

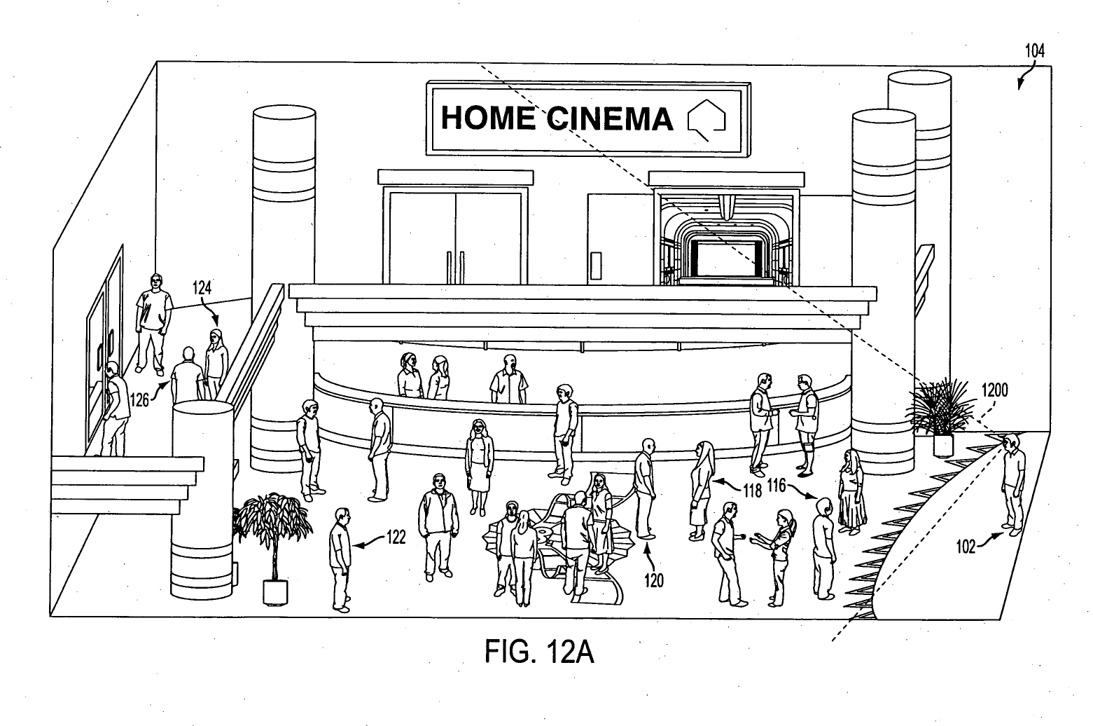

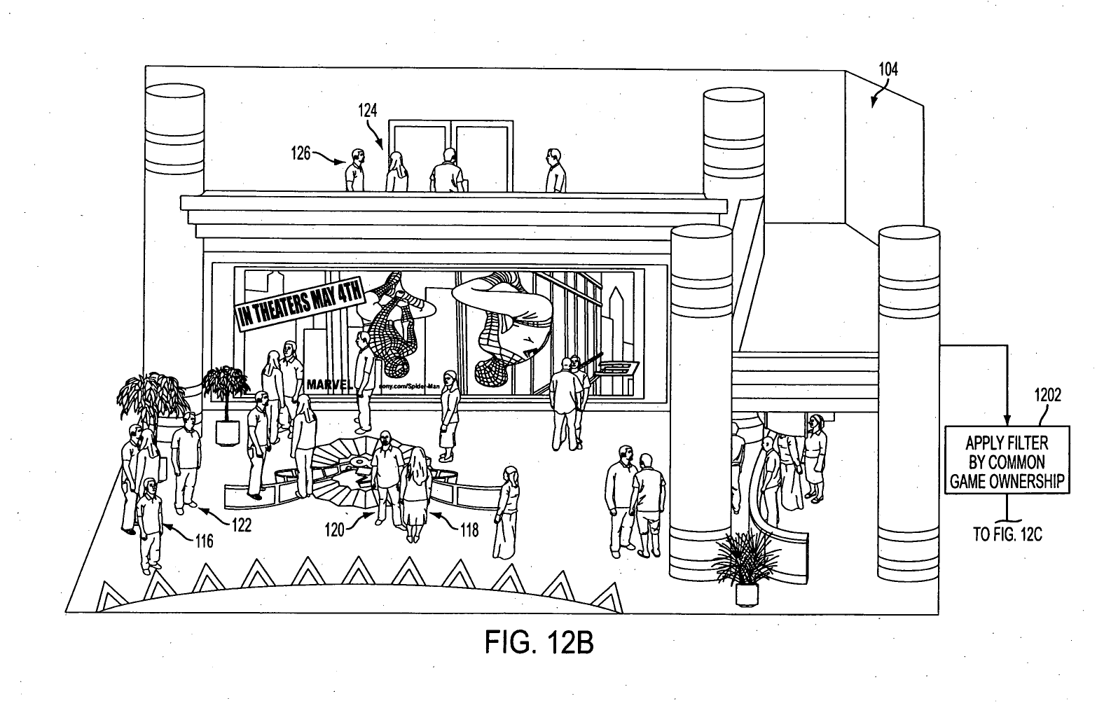

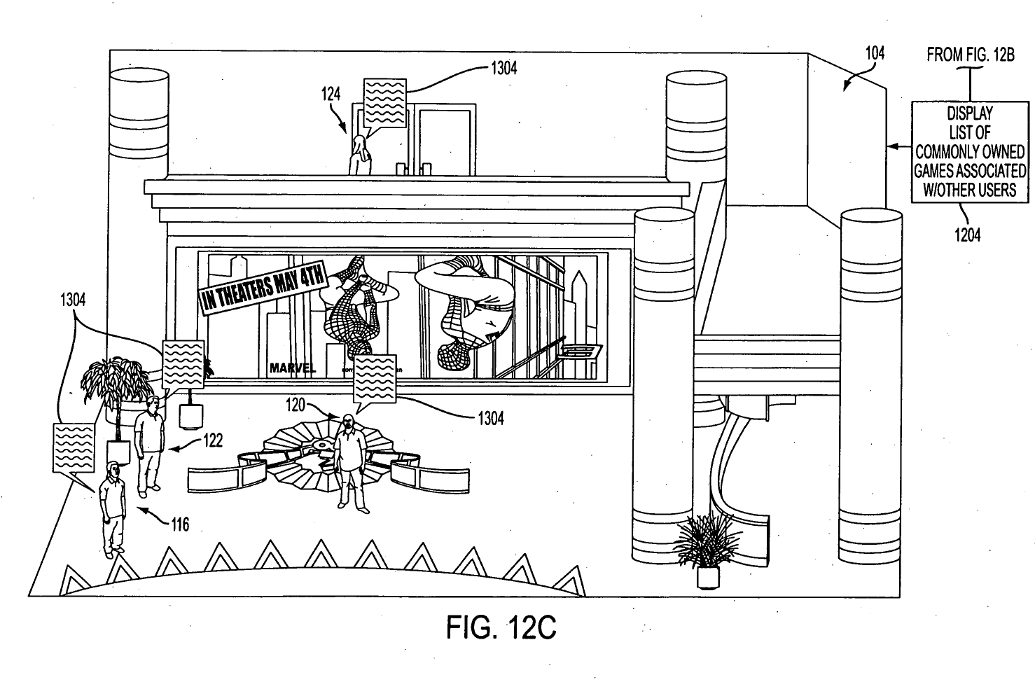

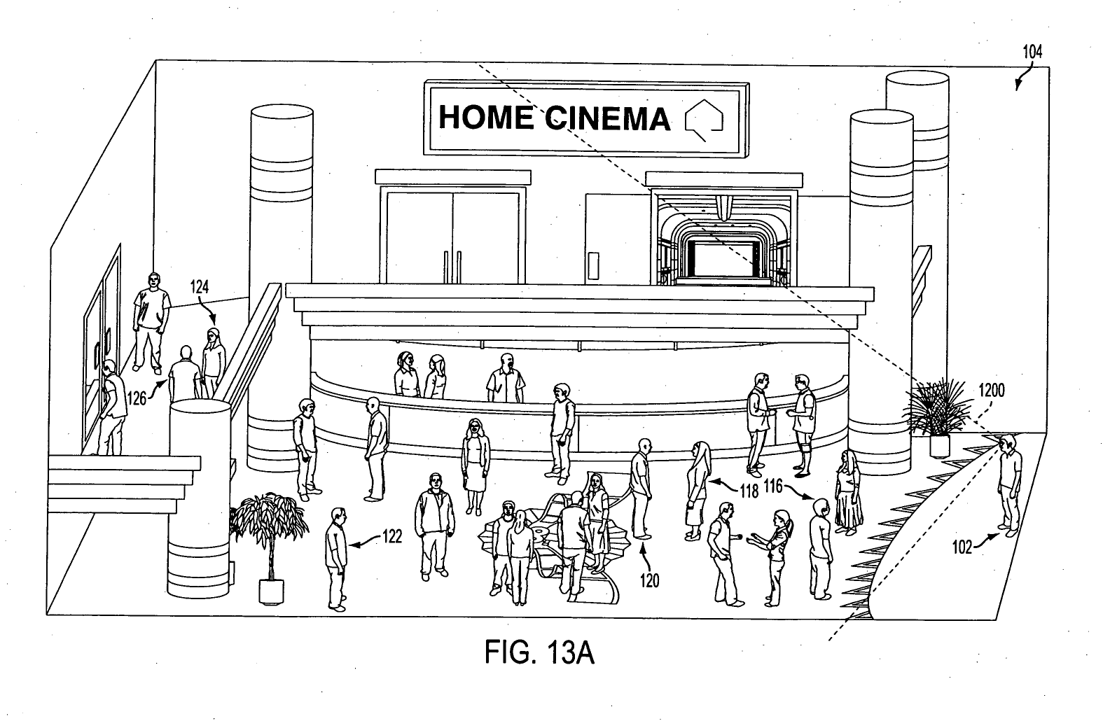

FIG. 12A illustrates an example similar to FIG. 11A where the cinema space 104 is a crowded environment of users and user A102 is viewing the room from his field of view 1100. In FIG. 12B, operation 1202 is performed so that a filter is applied to the room based on common game ownership.

For instance, if particular users within the cinema space 104 are players of a specific type of game, own specific types of games, or wish to interact with other users regarding specific games, those specific users will be quickly identified to user A102. As shown in FIG. 12C, operation 1204 displays a list of commonly owned games associated with other users. One embodiment will illustrate clouds over the identified users which may list out the various games that are commonly owned. Users that do not have a commonly owned game or an interest in a common game may not have the identifying cloud. Thus the user can quickly identify and approach those users which may have a common interest in discussing their abilities, or a desire to strike up an on-line game for competition purposes. In one embodiment, the list of commonly owned games 1304 may be in the form of listed alphanumeric descriptors, logos associated with the various games, and other identifying information.

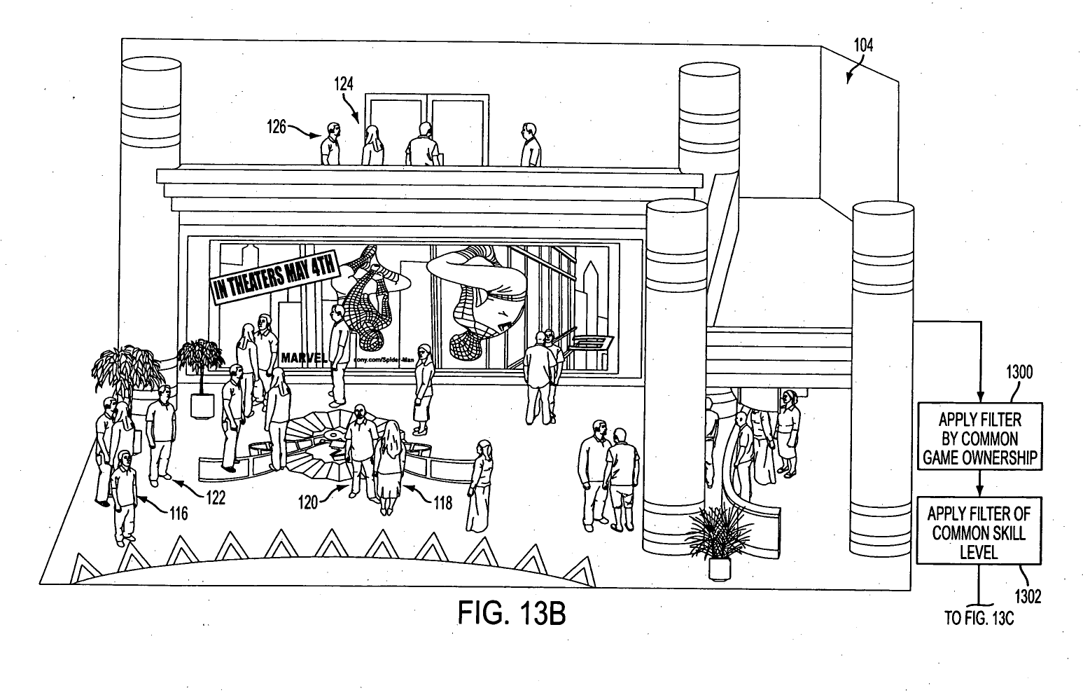

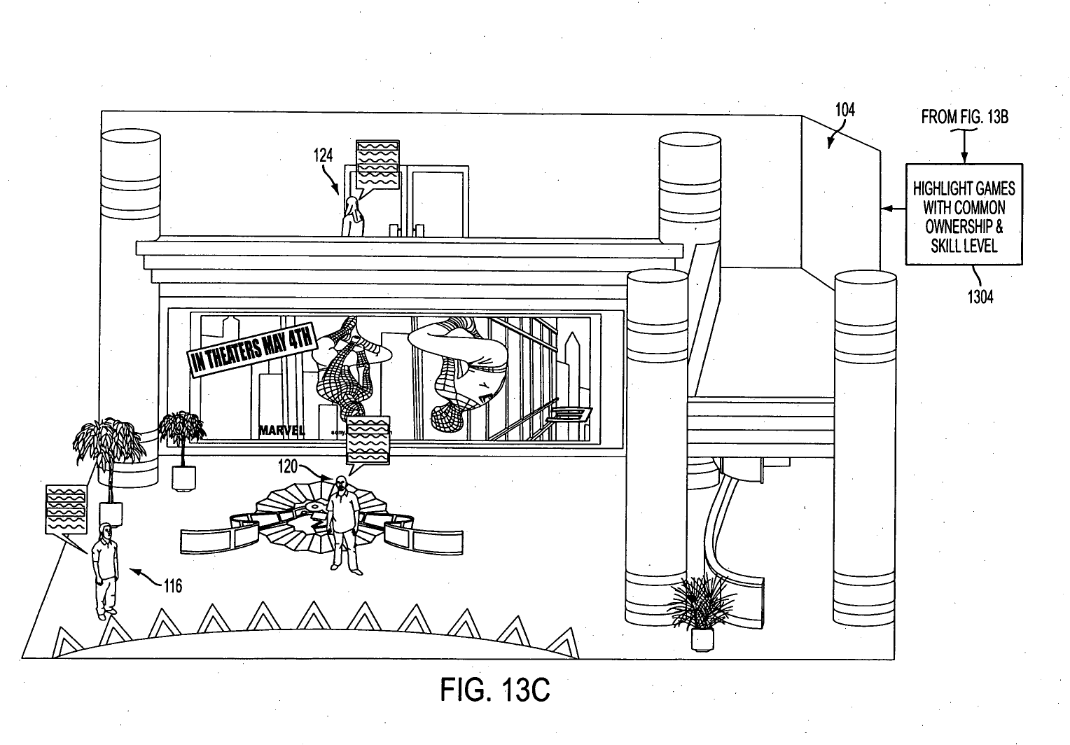

FIG. 13A illustrates the cinema space 104 again from the perspective of user A102. The field of view 1100 will thus be with respect to the user A102 and not with respect to other users. However, each of the users that are controlling their avatar within the cinema space 104 will have their own field of view and perspective and will be provided with a capabilities of filtering, striking up conversations, and other interactive activities. FIG. 13B shows an example where operations 1300 and 1302 are performed such that filters are rendered to apply common game ownership as well as common skill level.

By identify the common skill level in addition to the common game ownership functionality, FIG. 13C will show the application of operation 1304 that applies highlights to games with common ownership and skill level. By understanding the common skill level and common ownership of games, a user may approach other users to discuss game related details, share experiences, or suggest that a game be played with those users that possess the same skill level.

In one embodiment, each commonly owned game can have different identifiers, which can be highlighted with different colors. These colors can identify or indicate compatible skill level and could also include an arrow indicating if a skill level is higher or lower than the current user that is viewing the room from his or her perspective. Thus, users would be allowed to approach or not approach specific users within a virtual space and strike up conversations, hang out with, or suggest game play with equally or compatibly skilled players.

As noted above, the real-world controlled avatars can co-exist in virtual places with avatars that are controlled by a machine. Avatars that are controlled by a machine may be referred to as avatar bots, and such avatar bots can interact with other avatar bots or avatars that are controlled by a real-world user. In some cases, the avatar bots can work with other avatar bots to accomplish tasks, such as real people sometimes collaborate to accomplish a real world task. A task can include the building of a virtual space, direct advertising to real-world users or their avatars, building of advertising banners, posting of advertising messages, setting who can view certain messages based on filters, etc. In the virtual space, avatar bots can also travel or teleport to different locations, post outdoor signs, banners or ads, and define things, stores and pricing.

In still another aspect of the present invention, avatars need not be controlled by a game controller. Other ways of controlling an avatar may be by way of voice commands, keyboard key stokes, combination of key strokes, directional arrows, touch screens, computer pen pads, joysticks, steering whiles, inertial sensor hand-held objects, entertainment seats equipped with body sensors, head sensors, motion sensors, touch sensors, voice translation commands, etc.

In one embodiment, the virtual world program may be executed partially on a server connected to the internet and partially on the local computer (e.g., game console, desktop, laptop, or wireless hand held device). Still further, the execution can be entirely on a remote server or processing machine, which provides the execution results to the local display screen. In this case, the local display or system should have minimal processing capabilities to receive the data over the network (e.g., like the Internet) and render the graphical data on the screen.

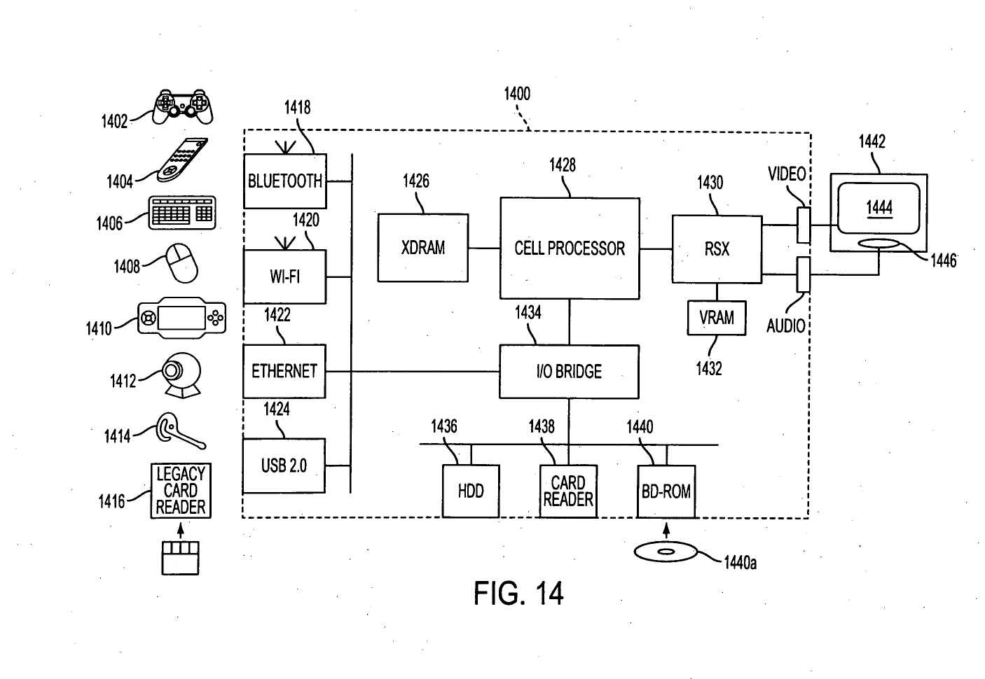

FIG. 14 schematically illustrates the overall system architecture of the Sony® Playstation 3® entertainment device, a console that may be compatible with controllers for implementing an avatar control system in accordance with one embodiment of the present invention. A system unit 1400 is provided, with various peripheral devices connectable to the system unit 1400. The system unit 1400 comprises: a Cell processor 1428; a Rambus® dynamic random access memory (XDRAM) unit 1426; a Reality Synthesizer graphics unit 1430 with a dedicated video random access memory (VRAM) unit 1432; and an I/O bridge 1434. The system unit 1400 also comprises a Blu Ray® Disk BD-ROM® optical disk reader 1440 for reading from a disk 1440a and a removable slot-in hard disk drive (HDD) 1436, accessible through the I/O bridge 1434. Optionally the system unit 1400 also comprises a memory card reader 1438 for reading compact flash memory cards, Memory Stick® memory cards and the like, which is similarly accessible through the I/O bridge 1434.

The I/O bridge 1434 also connects to six Universal Serial Bus (USB) 2.0 ports 1424; a gigabit Ethernet port 1422; an IEEE 802.11b/g wireless network (Wi-Fi) port 1420; and a Bluetooth® wireless link port 1418 capable of supporting of up to seven Bluetooth connections.

In operation the I/O bridge 1434 handles all wireless, USB and Ethernet data, including data from one or more game controllers 1402. For example when a user is playing a game, the I/O bridge 1434 receives data from the game controller 1402 via a Bluetooth link and directs it to the Cell processor 1428, which updates the current state of the game accordingly.

The wireless, USB and Ethernet ports also provide connectivity for other peripheral devices in addition to game controllers 1402, such as: a remote control 1404; a keyboard 1406; a mouse 1408; a portable entertainment device 1410 such as a Sony Playstation Portable® entertainment device; a video camera such as an EyeToy® video camera 1412; and a microphone headset 1414. Such peripheral devices may therefore in principle be connected to the system unit 1400 wirelessly; for example the portable entertainment device 1410 may communicate via a Wi-Fi ad-hoc connection, whilst the microphone headset 1414 may communicate via a Bluetooth link.

The provision of these interfaces means that the Playstation 3 device is also potentially compatible with other peripheral devices such as digital video recorders (DVRs), set-top boxes, digital cameras, portable media players, Voice over IP telephones, mobile telephones, printers and scanners.

In addition, a legacy memory card reader 1416 may be connected to the system unit via a USB port 1424, enabling the reading of memory cards 1448 of the kind used by the Playstation® or Playstation 2® devices.

In the present embodiment, the game controller 1402 is operable to communicate wirelessly with the system unit 1400 via the Bluetooth link. However, the game controller 1402 can instead be connected to a USB port, thereby also providing power by which to charge the battery of the game controller 1402. In addition to one or more analog joysticks and conventional control buttons, the game controller is sensitive to motion in six degrees of freedom, corresponding to translation and rotation in each axis. Consequently gestures and movements by the user of the game controller may be translated as inputs to a game in addition to or instead of conventional button or joystick commands. Optionally, other wirelessly enabled peripheral devices such as the Playstation™ Portable device may be used as a controller. In the case of the Playstation™ Portable device, additional game or control information (for example, control instructions or number of lives) may be provided on the screen of the device. Other alternative or supplementary control devices may also be used, such as a dance mat (not shown), a light gun (not shown), a steering wheel and pedals (not shown) or bespoke controllers, such as a single or several large buttons for a rapid-response quiz game (also not shown).

The remote control 1404 is also operable to communicate wirelessly with the system unit 1400 via a Bluetooth link. The remote control 1404 comprises controls suitable for the operation of the Blu Ray™ Disk BD-ROM reader 1440 and for the navigation of disk content.

The Blu Ray™ Disk BD-ROM reader 1440 is operable to read CD-ROMs compatible with the Playstation and PlayStation 2 devices, in addition to conventional pre-recorded and recordable CDs, and so-called Super Audio CDs. The reader 1440 is also operable to read DVD-ROMs compatible with the Playstation 2 and PlayStation 3 devices, in addition to conventional pre-recorded and recordable DVDs. The reader 1440 is further operable to read BD-ROMs compatible with the Playstation 3 device, as well as conventional pre-recorded and recordable Blu-Ray Disks.

The system unit 1400 is operable to supply audio and video, either generated or decoded by the Playstation 3 device via the Reality Synthesizer graphics unit 1430, through audio and video connectors to a display and sound output device 1442 such as a monitor or television set having a display 1444 and one or more loudspeakers 1446. The audio connectors 1450 may include conventional analogue and digital outputs whilst the video connectors 1452 may variously include component video, S-video, composite video and one or more High Definition Multimedia Interface (HDMI) outputs. Consequently, video output may be in formats such as PAL or NTSC, or in 720p, 1080i or 1080p high definition.

Audio processing (generation, decoding and so on) is performed by the Cell processor 1428. The Playstation 3 device's operating system supports Dolby® 5.1 surround sound, Dolby® Theatre Surround (DTS), and the decoding of 7.1 surround sound from Blu-Ray® disks.

In the present embodiment, the video camera 1412 comprises a single charge coupled device (CCD), an LED indicator, and hardware-based real-time data compression and encoding apparatus so that compressed video data may be transmitted in an appropriate format such as an intra-image based MPEG (motion picture expert group) standard for decoding by the system unit 1400. The camera LED indicator is arranged to illuminate in response to appropriate control data from the system unit 1400, for example to signify adverse lighting conditions. Embodiments of the video camera 1412 may variously connect to the system unit 1400 via a USB, Bluetooth or Wi-Fi communication port. Embodiments of the video camera may include one or more associated microphones and also be capable of transmitting audio data. In embodiments of the video camera, the CCD may have a resolution suitable for high-definition video capture. In use, images captured by the video camera may for example be incorporated within a game or interpreted as game control inputs.

In general, in order for successful data communication to occur with a peripheral device such as a video camera or remote control via one of the communication ports of the system unit 1400, an appropriate piece of software such as a device driver should be provided. Device driver technology is well-known and will not be described in detail here, except to say that the skilled man will be aware that a device driver or similar software interface may be required in the present embodiment described.

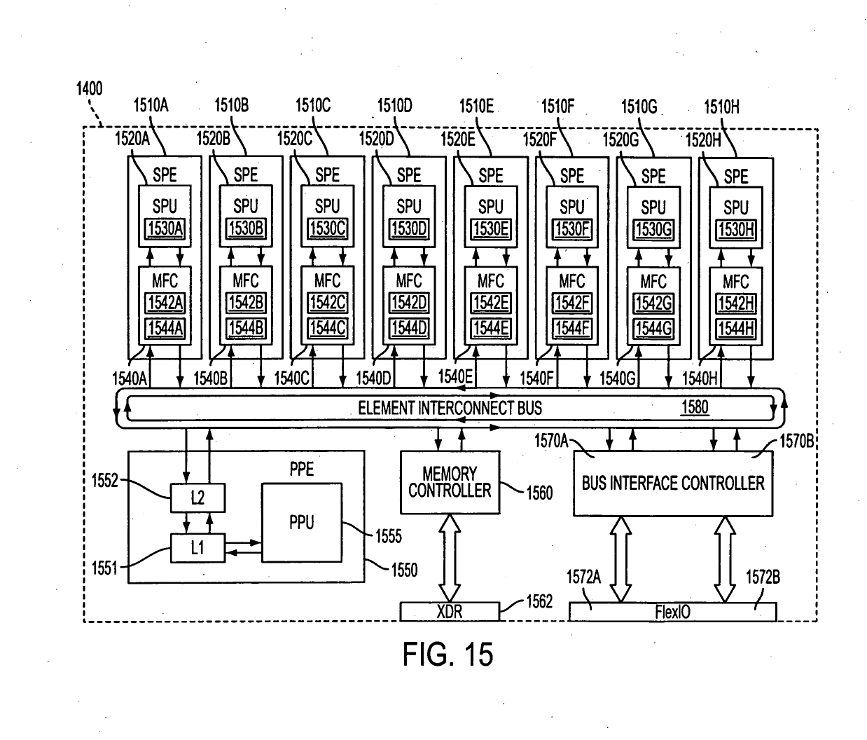

Referring now to FIG. 15, the Cell processor 1428 has an architecture comprising four basic components: external input and output structures comprising a memory controller 1560 and a dual bus interface controller 1570A,B; a main processor referred to as the Power Processing Element 1550; eight co-processors referred to as Synergistic Processing Elements (SPEs) 1510A-H; and a circular data bus connecting the above components referred to as the Element Interconnect Bus 1580. The total floating point performance of the Cell processor is 218 GFLOPS, compared with the 6.2 GFLOPs of the Playstation 2 device's Emotion Engine.

The Power Processing Element (PPE) 1550 is based upon a two-way simultaneous multithreading Power 1470 compliant PowerPC core (PPU) 1555 running with an internal clock of 3.2 GHz. It comprises a 512 kB level 2 (L2) cache and a 32 kB level 1 (L1) cache. The PPE 1550 is capable of eight single position operations per clock cycle, translating to 25.6 GFLOPs at 3.2 GHz. The primary role of the PPE 1550 is to act as a controller for the Synergistic Processing Elements 1510A-H, which handle most of the computational workload. In operation the PPE 1550 maintains a job queue, scheduling jobs for the Synergistic Processing Elements 1510A-H and monitoring their progress. Consequently each Synergistic Processing Element 1510A-H runs a kernel whose role is to fetch a job, execute it and synchronized with the PPE 1550.

Each Synergistic Processing Element (SPE) 1510A-H comprises a respective Synergistic Processing Unit (SPU) 1520A-H, and a respective Memory Flow Controller (MFC) 1540A-H comprising in turn a respective Dynamic Memory Access Controller (DMAC) 1542A-H, a respective Memory Management Unit (MMU) 1544A-H and a bus interface (not shown). Each SPU 1520A-H is a RISC processor clocked at 3.2 GHz and comprising 256 kB local RAM 1530A-H, expandable in principle to 4 GB. Each SPE gives a theoretical 25.6 GFLOPS of single precision performance. An SPU can operate on 4 single precision floating point members, 4 32-bit numbers, 8 16-bit integers, or 16 8-bit integers in a single clock cycle. In the same clock cycle it can also perform a memory operation. The SPU 1520A-H does not directly access the system memory XDRAM 1426; the 64-bit addresses formed by the SPU 1520A-H are passed to the MFC 1540A-H which instructs its DMA controller 1542A-H to access memory via the Element Interconnect Bus 1580 and the memory controller 1560.

The Element Interconnect Bus (EIB) 1580 is a logically circular communication bus internal to the Cell processor 1428 which connects the above processor elements, namely the PPE 1550, the memory controller 1560, the dual bus interface 1570A,B and the 8 SPEs 1510A-H, totaling 12 participants. Participants can simultaneously read and write to the bus at a rate of 8 bytes per clock cycle. As noted previously, each SPE 1510A-H comprises a DMAC 1542A-H for scheduling longer read or write sequences. The EIB comprises four channels, two each in clockwise and anti-clockwise directions. Consequently for twelve participants, the longest step-wise data-flow between any two participants is six steps in the appropriate direction. The theoretical peak instantaneous EIB bandwidth for 12 slots is therefore 96B per clock, in the event of full utilization through arbitration between participants. This equates to a theoretical peak bandwidth of 307.2 GB/s (gigabytes per second) at a clock rate of 3.2 GHz.

The memory controller 1560 comprises an XDRAM interface 1562, developed by Rambus Incorporated. The memory controller interfaces with the Rambus XDRAM 1426 with a theoretical peak bandwidth of 25.6 GB/s.

The dual bus interface 1570A,B comprises a Rambus FlexIO® system interface 1572A,B. The interface is organized into 12 channels each being 8 bits wide, with five paths being inbound and seven outbound. This provides a theoretical peak bandwidth of 62.4 GB/s (36.4 GB/s outbound, 26 GB/s inbound) between the Cell processor and the I/O Bridge 700 via controller 170A and the Reality Simulator graphics unit 200 via controller 170B.

Data sent by the Cell processor 1428 to the Reality Simulator graphics unit 1430 will typically comprise display lists, being a sequence of commands to draw vertices, apply textures to polygons, specify lighting conditions, and so on.

Embodiments may include capturing depth data to better identify the real-world user and to direct activity of an avatar or scene. The object can be something the person is holding or can also be the person's hand. In the this description, the terms “depth camera” and “three-dimensional camera” refer to any camera that is capable of obtaining distance or depth information as well as two-dimensional pixel information. For example, a depth camera can utilize controlled infrared lighting to obtain distance information. Another exemplary depth camera can be a stereo camera pair, which triangulates distance information using two standard cameras. Similarly, the term “depth sensing device” refers to any type of device that is capable of obtaining distance information as well as two-dimensional pixel information.

Recent advances in three-dimensional imagery have opened the door for increased possibilities in real-time interactive computer animation. In particular, new “depth cameras” provide the ability to capture and map the third-dimension in addition to normal two-dimensional video imagery. With the new depth data, embodiments of the present invention allow the placement of computer-generated objects in various positions within a video scene in real-time, including behind other objects.

Moreover, embodiments of the present invention provide real-time interactive gaming experiences for users. For example, users can interact with various computer-generated objects in real-time. Furthermore, video scenes can be altered in real-time to enhance the user's game experience. For example, computer generated costumes can be inserted over the user's clothing, and computer generated light sources can be utilized to project virtual shadows within a video scene. Hence, using the embodiments of the present invention and a depth camera, users can experience an interactive game environment within their own living room. Similar to normal cameras, a depth camera captures two-dimensional data for a plurality of pixels that comprise the video image. These values are color values for the pixels, generally red, green, and blue (RGB) values for each pixel. In this manner, objects captured by the camera appear as two-dimension objects on a monitor.

Embodiments of the present invention also contemplate distributed image processing configurations. For example, the invention is not limited to the captured image and display image processing taking place in one or even two locations, such as in the CPU or in the CPU and one other element. For example, the input image processing can just as readily take place in an associated CPU, processor or device that can perform processing; essentially all of image processing can be distributed throughout the interconnected system. Thus, the present invention is not limited to any specific image processing hardware circuitry and/or software. The embodiments described herein are also not limited to any specific combination of general hardware circuitry and/or software, nor to any particular source for the instructions executed by processing components.

With the above embodiments in mind, it should be understood that the invention may employ various computer-implemented operations involving data stored in computer systems. These operations include operations requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

The above described invention may be practiced with other computer system configurations including hand-held devices, microprocessor systems, microprocessor-based or programmable consumer electronics, minicomputers, mainframe computers and the like. The invention may also be practiced in distributing computing environments where tasks are performed by remote processing devices that are linked through a communications network.

The invention can also be embodied as computer readable code on a computer readable medium. The computer readable medium is any data storage device that can store data which can be thereafter read by a computer system, including an electromagnetic wave carrier. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. An interactive virtual environment for communication, the interactive virtual environment depicted from images displayed on a display and the interactive virtual environment being generated by a computer program that is executed in a computer network system, the virtual environment including one or more virtual user avatars controlled by real-world users, comprising:
controlling a virtual user avatar to move about a virtual space;
composing a message and generating a virtual message within the virtual space, the virtual message being applied to an interactive space within the virtual space; and
assigning permissions to the virtual message, the permissions defining which of the one more virtual user avatars are able to view the virtual message that is applied to an interactive space;
wherein the virtual message is one of a plurality of virtual message applied to the interactive space, the permissions preventing viewing of the virtual message by virtual user avatars that do not have permission to view the virtual message.

2. An interactive virtual environment for communication as recited in claim 1, further comprising:
graphically displaying the virtual message as a graphic image in a scene of the virtual space;
moving the graphic image of the virtual message through graphic control of a virtual user avatar, the virtual user avatar being controlled by a real-world user through a controller, the controller being connected to a computing console, the computing console being connected to the computer network system.

3. An interactive virtual environment for communication as recited in claim 2, wherein moving the graphic image of the virtual message enables applying of the virtual message to the interactive space.

4. An interactive virtual environment for communication as recited in claim 1, wherein the applying is one of a virtual posting of a message, writing of a message, drawing a message, pasting a message, or pinning a message.

5. An interactive virtual environment for communication as recited in claim 1, wherein the interactive space is in the interactive virtual environment, and the interactive space is graphically displayed as object.

6. An interactive virtual environment for communication as recited in claim 5, wherein the object is a bulletin board, a message board, a wall, a building, a paper, a shape, or a combination thereof.

7. An interactive virtual environment for communication as recited in claim 1, further comprising:
defining the permissions based on one of buddy lists, game familiarity relative to other real-world users, skill level of other real-world users, and combinations thereof.

8. An interactive virtual environment for communication as recited in claim 1, further comprising:
filtering virtual messages on the interactive space based on geographic location of a real-world user that is controlling its virtual user avatar, the geographic location defining message content most relevant to the real-world user viewing the interactive space from a view point of its virtual user avatar.

9. An interactive virtual environment for communication as recited in claim 1, further comprising:
filtering the virtual messages on the interactive space based on personal preferences.

10. An interactive virtual environment for communication as recited in claim 1, further comprising:
populating the personal preferences options based on geographic location of the real-world user that is controlling its virtual user avatar in the virtual space.

11. An interactive virtual environment for communication as recited in claim 1, further comprising:
providing virtual glasses to the virtual user avatars, the virtual glasses being assigned particular privileges to view selected ones of the virtual messages in a virtual space.

12. An interactive virtual environment for communication as recited in claim 11, further comprising:
enabling control of the virtual glasses through controlled avatar movement as dictated by a real-world user that controls its virtual user avatar;
enabling selection of virtual glasses;
enabling placement of the virtual glasses onto eyes of the virtual user avatar; and
providing clear view to message content of particular ones of the virtual messages not previously viewable without the virtual glasses.

13. An interactive virtual environment for communication as recited in claim 1, further comprising:
filtering virtual user avatars in a scene from a perspective of each virtual user avatar, such that the filtering highlights selected virtual user avatars that are part of a respective virtual user avatar's buddy list, selected virtual user avatars having a common video game interest, selected virtual user avatars having a particular skill level, or a combination thereof.

14. A method for rendering an interactive virtual environment for communication, the interactive virtual environment depicted from images to be displayed on a display and the interactive virtual environment being generated by a computer program that is executed on at least one computer of a computer network system, the interactive virtual environment including one or more virtual user avatars controlled by real-world users, comprising:
controlling a virtual user avatar to move about a virtual space;
generating an interface for composing a message to be displayed as a virtual message within the virtual space, the virtual message posted to an interactive space within the virtual space; and
associating permissions to the virtual message, the permissions defining which of the one more virtual user avatars are able to view the virtual message that is posted to the interactive space;
wherein the virtual message is one of a plurality of virtual message posted to the interactive space, the permissions preventing viewing of the virtual message by virtual user avatars that do not have permission to view the virtual message, and the permissions based on one of buddy lists, game familiarity relative to other real-world users, skill level of other real-world users, and combinations thereof.

15. A method for rendering an interactive virtual environment as recited in claim 14, further comprising:
filtering the virtual messages on the interactive space based on personal preferences.

16. A method for rendering an interactive virtual environment as recited in claim 15, further comprising:
populating the personal preferences options based on geographic location of the real-world user that is controlling its virtual user avatar in the virtual space.

17. A method for rendering an interactive virtual environment as recited in claim 14, further comprising:
filtering virtual user avatars in a scene from a perspective of each virtual user avatar, such that the filtering highlights selected virtual user avatars that are part of a respective virtual user avatar's buddy list, selected virtual user avatars having a common video game interest, selected virtual user avatars having a particular skill level, or a combination thereof.

18. A method for rendering an interactive virtual environment as recited in claim 14, wherein the posted message is one of a virtual posting of a message in the virtual space, writing of a message in the virtual space, drawing a message in the virtual space, spray painting in the virtual space, pasting a message in the virtual space, or pinning a message in the virtual space.

19. A method for rendering an interactive virtual environment for communication, the interactive virtual environment depicted from images to be displayed on a display and the interactive virtual environment being generated by a computer program that is executed on at least one computer of a computer network system, the interactive virtual environment including one or more virtual user avatars controlled by real-world users, comprising:
controlling a virtual user avatar to move about a virtual space;
generating an interface for composing a message to be displayed as a virtual message within the virtual space, the virtual message posted to an interactive space within the virtual space; and
associating permissions to the virtual message, the permissions defining which of the one more virtual user avatars are able to view the virtual message that is posted to the interactive space;
graphically displaying the virtual message as a graphic image in a scene of the virtual space; and
moving the graphic image of the virtual message through graphic control of a virtual user avatar, the virtual user avatar being controlled by a real-world user through a controller.

20. A method for rendering an interactive virtual environment for communication as recited in claim 19, wherein the controller is connected to a computing console, the computing console being connected to the computer network system.

21. A method for rendering an interactive virtual environment for communication as recited in claim 19, wherein moving the graphic image of the virtual message enables applying of the virtual message to the interactive space.

22. A method for rendering an interactive virtual environment for communication as recited in claim 19, wherein the virtual message is one of a plurality of virtual message posted to the interactive space, the permissions preventing viewing of the virtual message by virtual user avatars that do not have permission to view the virtual message, and the permissions based on one of buddy lists, game familiarity relative to other real-world users, skill level of other real-world users, and combinations thereof.

23. An interactive virtual environment for communication, the interactive virtual environment depicted from images displayed on a display and the interactive virtual environment being generated by a computer program that is executed in a computer network system, the virtual environment including one or more virtual user avatars controlled by real-world users or computer programs, comprising:
controlling a virtual user avatar to move about a virtual space;
posting a message within the virtual space, the virtual message being applied to an interactive space within the virtual space; and
assigning permissions to the message, the permissions defining which of the one more virtual user avatars are able to view the message that is applied to the interactive space;
wherein the message is one of a plurality of messages applied to the interactive space, the permissions preventing viewing of the message by virtual user avatars that do not have permission to view the message.

24. An interactive virtual environment for communication as recited in claim 23, wherein the message having communication data or advertising data.

25. An interactive virtual environment for communication as recited in claim 23, wherein the posting is done by the virtual user avatar that is controlled by the real-world user.

26. An interactive virtual environment for communication as recited in claim 23, wherein the posting is done by the virtual user avatar that is computer controlled.
